(19) United States
(12) Patent Application Publication
(10) Pub. No.: US 2026/0261464 A1
(43) Pub. Date: Sep. 3, 2026

(54) MOBILITY IN WIRELESS COMMUNICATION SYSTEMS

(71) Applicant: Nokia Technologies Oy, Espoo (FI)

(72) Inventors: Timo KOSKELA, Oulu (FI); Sanjay GOYAL, Murray Hill, NJ (US); Keeth Saliya Jayasinghe LADDU, Espoo (FI); Ali KARIMIDEHKORDI, Munich (DE); Ahmad AWADA, Munich (DE); Panagiotis SPAPIS, Munich (DE)

(21) Appl. No.: 19/196,380

(22) PCT Filed: Oct. 18, 2023
(86) PCT No.: PCT/EP2023/078989

§ 371 Date: May 1, 2025

(30) Foreign Application Priority Data
Nov. 7, 2022 (GB) 2216564.1

(51) Int. Cl. H04L 27/26; H04L 5/00; H04W 74/0833

(52) U.S. Cl. CPC H04L 27/261; H04L 5/0044; H04W 74/0833

(57) ABSTRACT

Various example embodiments relate to wireless communication systems, and more particularly, to facilitating mobility within such wireless communication systems. Aspects and embodiments relate to at least user equipment of a radio access network and methods performed by that user equipment. According to one aspect, the user equipment comprises: at least one processor; and at least one memory storing instructions that, when executed by the at least one processor, cause the user equipment at least to: determine that the user equipment is configured to apply layer 1 or layer 2 triggered mobility; receive a reference signal configuration associated with a reference signal receivable from one or more network node of the radio access network, wherein the configuration may comprise a configuration of a reference signal receivable from a target network node; receive a mobility trigger indicating that the user equipment is to switch to the target network node, wherein the mobility trigger may include a configuration associated with a reference signal receivable from the target network node; switch to the target network node; assess whether the mobility trigger or received reference signal configuration includes a configuration associated with a reference signal receivable from the target network node, and if so, monitor the reference signal receivable from the target network node in accordance with the assessed associated configuration. Arrangements recognise that mechanisms which may be adopted for serving cell beam management may not be well suited to cases where lower layer triggered mobility is operational. Implementations and arrangements described leverage information provided, for example, by the transmission configuration indicator TCI state information, to user equipment for communication with a target cell without requiring the user equipment have active TCI State for the target cell, before the target cell activates a TCI state. According to some described aspects user equipment may not need to be pre-activated with TCI States that it applies upon handover i.e. the beam indication does not have to refer to a candidate RRC configuration that is not yet active (before the handover). Such implementations and arrangements relax user equipment implementation requirements and simplify network signalling required in support of a mobility event.

### TECHNOLOGICAL FIELD

Various example embodiments relate to wireless communication systems, and more particularly, to facilitating mobility within such wireless communication systems.

### BACKGROUND

Wireless communications systems are subject to ongoing development and evolution. Such developments and evolution include the provision of systems which support multiple transmission and reception points (multi-TRP) and provision of various antenna configurations at transmission and reception nodes in a network.

As user equipment (UE) moves through a wireless communication system, it may move through regions of radio coverage supported by one or more network access node. Maintaining an ability for UE to communicate effectively with the wireless communication system as it moves through regions of radio coverage is typically referred to as mobility. The operational characteristics of network access nodes within a wireless communication network may differ.

Some adaptations to wireless communication devices, infrastructure and signalling may be required to support mobility as wireless communications systems develop and evolve.

### BRIEF SUMMARY

The scope of protection sought for various example embodiments of the invention is set out by the independent claims. The example embodiments and features, if any, described in this specification that do not fall under the scope of the independent claims are to be interpreted as examples useful for understanding various embodiments of the invention.

According to various, but not necessarily all, example embodiments there is provided user equipment of a radio access network comprising: at least one processor; and at least one memory storing instructions that, when executed by the at least one processor, cause the user equipment at least to: determine that the user equipment is configured to apply layer 1 or layer 2 triggered mobility; receive a reference signal configuration associated with a reference signal receivable from one or more network node of the radio access network, wherein the configuration may comprise a configuration of a reference signal receivable from a target network node; receive a mobility trigger indicating that the user equipment is to switch to the target network node, wherein the mobility trigger may include a configuration associated with a reference signal receivable from the target network node; switch to the target network node; assess whether the mobility trigger or received reference signal configuration includes a configuration associated with a reference signal receivable from the target network node, and if so, monitor the reference signal receivable from the target network node in accordance with the assessed associated configuration.

According to some embodiments, one of the one or more network node is a network node supporting the serving cell the user equipment is connected to.

According to some embodiments, the target network node is a network node supporting the target cell or target candidate cell. The target cell or target candidate sell may comprise a cell the user equipment is to switch to from a serving cell.

According to some embodiments, the network node supporting the serving cell and the network node supporting the target cell or target candidate cell are the same node or are different nodes, both nodes being physically co-located or not.

According to some embodiments, there is provided user equipment of a radio access network comprising: at least one processor; and at least one memory storing instructions that, when executed by the at least one processor, cause the user equipment to operate and perform steps as follows:

The user equipment may determine that the user equipment is configured to apply layer 1 or layer 2 triggered mobility. The determination may be based upon receipt of a configuration message or indication from the network. The configuration may comprise a Radio Resource Control RRC message. The message may be received from a serving cell or serving network node of the user equipment.

The user equipment may receive a reference signal configuration associated with a reference signal receivable from one or more network node of the radio access network. The reference signal configuration may be received at the user equipment. The reference signal configuration may be based upon receipt of a configuration message or indication from the network. The reference signal configuration may be based upon receipt of a configuration message or indication from a serving cell or serving network node of the user equipment. The receiving may comprise receiving a Radio Resource Control RRC message; or Medium Access Control(MAC) control element CE. The reference signal configuration may comprise any appropriate indication or mapping of a configuration of a reference signal. The reference signal configuration may, for example, comprise, for example, a transmission configuration indication (TCI) state, a quasi colocation QCL indication of a reference signal, a direct indication of a reference signal, or an Inter Cell Beam Management ICBM reference.

The received configuration may comprise: a configuration of a reference signal receivable from a target network node. The received configuration may comprise a configuration associated with the serving cell or network node. The received configuration may comprise a configuration associated with a cell other than the serving cell or target cell. The configuration may explicitly include a reference configuration associated with a serving cell of the user equipment, for example, TCI state, QCL, reference signal). The configuration may, or may not, further include an explicit reference configuration associated with a target cell and/or an implicit reference configuration associated with a target cell. Such an implicit reference may, for example, be in some way associated with a serving cell configuration.

The user equipment may receive a mobility trigger indicating that the user equipment is to switch to the target network node. The mobility trigger may be received at the user equipment. The mobility trigger may be based upon receipt of a configuration message or indication from the network. The mobility trigger may be based upon receipt of a configuration message or indication from a serving cell or serving network node of the user equipment. The mobility trigger maybe sent as part of a MAC CE message sent from a serving network node to the UE, ie the serving network node supporting a serving cell to which the UE is connected, and may include or support functionality of a Distributed Unit (DU).

The mobility trigger may include a configuration associated with a reference signal receivable from the target network node. As described above, the received configuration may comprise: a configuration of a reference signal receivable from a target network node. The received configuration may comprise a configuration associated with the serving cell or network node. The received configuration may comprise a configuration associated with a cell other than the serving cell or target cell. The configuration may explicitly include a reference configuration associated with a serving cell of the user equipment, for example, TCI state, QCL, reference signal). The configuration may, or may not, further include an explicit reference configuration associated with a target cell and/or an implicit reference configuration associated with a target cell. Such an implicit reference may, for example, be in some way associated with a serving cell configuration.

The user equipment may switch to the target network node. Switching may, for example, include a handover from a serving cell to a target cell. Switching may, for example, comprise a UE performing for example, a random access procedure to perform the handover/switch to a target cell. Switching may occur without the user equipment performing a random access procedure to the target cell. Switching may be performed after assessing step, thus assessing may be performed before any such switching step.

The user equipment may assess whether the mobility trigger or received reference signal configuration includes a configuration associated with a reference signal receivable from the target network node.

In response to detecting the mobility trigger or the received reference signal configuration include a configuration associated or associable with a reference signal receivable from the target network node, the user equipment may be configured to monitor the reference signal receivable from the target network node in accordance with the detected associated configuration.

In response to detecting both the mobility trigger and the received reference signal configuration include a configuration associated or associable with a reference signal receivable from the target network node, the user equipment may pick the most recent received configuration, and the user equipment may then be configured to monitor the reference signal receivable from the target network node in accordance with the detected associated configuration.

In response to detecting that neither the mobility trigger nor the received reference signal configuration include a configuration associated or associable with a reference signal receivable from the target network node, the user equipment may be configured to perform a random access procedure towards the target mode.

The user equipment may be further caused to: assume that a reference signal configuration associated with a reference signal receivable from the target network node is unknown after the switch to the target network node.

According to some embodiments, the received reference signal configuration associated with a reference signal receivable from one or more network node of the radio access network comprises a Transmission Configuration Indicator state, and the configuration includes a Transmission Configuration Indicator state of a reference signal receivable from the target network node and wherein after the switch to the target network node, the user equipment is configured to not apply the Transmission Configuration Indicator state of the reference signal receivable from the target network node received prior to the switch to the target network node.

According to some embodiments, if the received reference signal configuration associated with a reference signal receivable from one or more network node of the radio access network includes a configuration of a reference signal receivable from a target network node, the user equipment is configured to: monitor the reference signal receivable from the target network node in accordance with the assessed associated configuration at least until the mobility trigger is received.

According to some embodiments, assessing whether the reference signal configuration associated with a reference signal or mobility trigger includes a configuration of a reference signal receivable from the target network node comprises: selecting the reference signal configuration associated with a reference signal receivable from the target network node received in the mobility trigger in preference to any reference signal configuration associated with a reference signal receivable from the target network node included in the reference signal configuration associated with a reference signal receivable from one or more network node of the radio access network. According to some embodiments, if the user equipment assesses that neither the reference signal configuration associated with a reference signal receivable from one or more network node of the radio access network nor mobility trigger includes a reference signal configuration associated with a reference signal receivable from the target network node; the user equipment is configured to: initiate a random access request to the target network node indicated by the mobility trigger.

According to some embodiments, the user equipment is configured to monitor the reference signal receivable from the target network node in accordance with the assessed associated configuration at least until an updated reference signal configuration associated with a reference signal receivable from one or more network node of the radio access network is received from the target network node.

According to some embodiments, monitoring the the reference signal receivable from the target network node in accordance with the assessed associated configuration comprises: monitoring at least one downlink channel received from the target network node based on the reference signal receivable from the target.

According to some embodiments, the user equipment is configured to perform a transmission based upon the assessed associated target cell configuration at least until an updated reference signal configuration associated with a reference signal receivable from one or more network node of the radio access network is received from the target network node.

According to some embodiments, the transmission comprises: transmitting at least one uplink channel based on the reference signal receivable from the target.

According to some embodiments, the reference signal configuration associated with a reference signal receivable from the target cell of the radio access network comprises at least one inter-cell beam management ICBM indicator.

According to some embodiments, the reference signal configuration associated with a reference signal receivable from one or more network node of the radio access network comprises at least one Transmission Configuration Indicator TCI state indicator.

According to some embodiments, the user equipment is configured to determine a downlink reference signal or quasi-co-located source reference signal in dependence upon a received Transmission Configuration Indicator state.

According to some embodiments, the user equipment is configured with at least one Transmission Configuration Indicator state which maps to a downlink reference signal index associated with the target network node.

According to some embodiments, the user equipment is configured to receive a Transmission Configuration Indicator state index which maps reference signals to Transmission Configuration Indicator states, the index being determined by the network.

According to some embodiments, the mobility trigger comprises a switch command or switch parameter to be met in relation to the target network node.

According to some embodiments, the mobility trigger comprises a medium access control layer control element MAC-CE or downlink control information DCI receivable by the user equipment.

According to some embodiments, the mobility trigger comprises: a Transmission Configuration Indicator TCI state which maps to a reference signal index associated with the target network node.

According to some embodiments, the mobility trigger comprises: a downlink reference signal configuration associated with the target network node.

According to some embodiments, receiving a reference signal configuration associated with a reference signal receivable from one or more network node of the radio access network comprise: receiving at least one Transmission Configuration Indicator TCI state, and wherein the at least one configuration of a reference signal receivable from a target network node comprises a Transmission Configuration Indicator TCI state associated with a physical cell identity which differs from that of a serving cell of the user equipment; and wherein receiving a mobility trigger indicating that the user equipment is to switch to the target network node, wherein the mobility trigger is associated with a Transmission Configuration Indicator TCI state associated with the target network node; and wherein the user equipment is configured to: determine a downlink reference signal indicated by the Transmission Configuration Indicator TCI state or a quasi colocated source reference signal of the reference signal indicated by the Transmission Configuration Indicator TCI state without mapping the Transmission Configuration Indicator TCI state to the target cell configuration; switch to the target network node; apply the determined downlink reference signal for monitoring at least one downlink channel and optionally transmission of at least one uplink channel; and assess that the user equipment does not have a Transmission Configuration Indicator TCI state in relation to the target cell, and applied at least one rule for a quasi collocated QCL assumption based on the applied reference signal.

According to some embodiments, for a CORESET other than a CORESET with index 0, if the user equipment has not been provided with a configuration of Transmission Configuration Indicator state(s) by: tci-StatesPDCCH-ToAddList and tci-StatesPDCCH-ToReleaseList for the CORESET; or has been provided initial configuration of more than one Transmission Configuration Indicator TCI states for the CORESET by tci-StatesPDCCH-ToAddList and tci-StatesPDCCH-ToReleaseList but has not received a MAC CE activation command for one of the TCI states;

the user equipment is configured to: assume that a demodulation reference signal DM-RS antenna port associated with Physical Downlink Control Channel PDCCH reception is quasi co-located with a Synchronisation Signal/Physical Broadcast Channel SS/PBCH block as identified by the user equipment for a most recently received Channel Status Information Reference Signal CSI-RS configured with Tracking Reference Signal TRS-info or a Synchronisation Signal Block SSB associated with a Physical Cell Identity PCI other than a serving cell provided to the user equipment indicated by determined Transmission Configuration Indicator TCI information; or optionally for the most recent Channel Status Information Reference Signal CSI-RS or Synchronisation Signal Block SSB index provided to the user equipment by a received configuration index provided by the mobility trigger or determination that the user equipment is configured to apply layer 1 or layer 2 triggered mobility as part of a Layer1/layer 2 triggered mobility LTM trigger command or an equivalent message triggering cell switch to a new target cell; or optionally for the most recent Channel Status Information Reference Signal CSI-RS or Synchronisation Signal Block SSB index provided to user equipment by the mobility trigger or determination that the user equipment is configured to apply layer 1 or layer 2 triggered mobility as part of a Layer1/layer 2 triggered mobility LTM trigger command from the user equipment serving cell indicated by a configuration index or in any message triggering cell switch to the target cell.

According to some embodiments, the received reference signal configuration associated with a reference signal receivable from one or more network node of the radio access network does not comprise a configuration of a reference signal receivable from a target network node; and the received mobility trigger indicating that the user equipment is to switch to the target network node does include a configuration of a reference signal receivable from the target network node; and wherein the user equipment is caused to: switch to the target network node; and monitor the reference signal receivable from the target network node in accordance with the configuration of the reference signal receivable from the target network node included in the received mobility trigger.

According to some embodiments, the user equipment is connected to a serving cell; wherein the received reference signal configuration associated with a reference signal receivable from one or more network node of the radio access network is received from the serving cell and does not comprise a configuration of a reference signal receivable from a target network node; wherein the received mobility trigger comprises a medium access control layer control element MAC CE message from the serving cell indicating that the user equipment is to switch to the target network node and includes a configuration of a reference signal receivable from the target network node in the form of a transmission configuration indicator TCI state or Quasi Co-located QCL source information relating to the target cell; and wherein the user equipment is caused to: determine a reference signal or source reference signal indicated by the TCI state or Quasi Co-located QCL source information; switch to the target network node; and monitor the reference signal receivable from the target network node by applying the determined reference signal for monitoring at least one downlink channel and optionally transmission of at least one uplink channel and wherein the user equipment is caused to consider it does not have an indicated transmission configuration indicator TCI state in relation to the target cell.

According to some embodiments, the received reference signal configuration associated with a reference signal receivable from one or more network node of the radio access network does not comprise a configuration of a reference signal receivable from a target network node; and the received mobility trigger indicating that the user equipment is to switch to the target network node does not include a configuration of a reference signal receivable from the target network node; and wherein the user equipment is caused to: determine that it is to switch to the target network node; and initiate a random access request to the target cell.

According to some embodiments, the user equipment is connected to a serving cell; the received reference signal configuration associated with a reference signal receivable from one or more network node of the radio access network is received from the serving cell and does not comprise a configuration of a reference signal receivable from a target network node; and the received mobility trigger comprises a medium access control layer control element MAC CE message from the serving cell indicating that the user equipment is to switch to the target network node and does not include a configuration of a reference signal receivable from the target network node; and wherein the user equipment is caused to: determine that it is to switch to the target network node; and initiate a contention based random access request to the target cell.

According to some embodiments, the received reference signal configuration associated with a reference signal receivable from one or more network node of the radio access network comprises a configuration of a reference signal receivable from a target network node; and the received mobility trigger indicating that the user equipment is to switch to the target network node does not include a configuration of a reference signal receivable from the target network node; and wherein the user equipment is caused to: switch to the target network node; and monitor the reference signal receivable from the target network node in accordance with the configuration of the reference signal receivable from the target network node included in the received reference signal configuration associated with a reference signal receivable from one or more network node of the radio access network.

According to some embodiments, the user equipment is connected to a serving cell; the received reference signal configuration associated with a reference signal receivable from one or more network node of the radio access network comprises medium access control layer control element MAC CE message from the serving cell and comprises a transmission configuration indicator TCI state or Inter cell Beam Management ICBM indication ((i.e. a TCI state of a cell with different PCI than serving cell is indicated to be applied by the UE for at least on DL or UL channel (or both))) relating to the target cell; and the received mobility trigger comprises a medium access control layer control element MAC CE message from the serving cell indicating that the user equipment is to switch to the target network node, wherein the received mobility trigger does not include a configuration of a reference signal receivable from the target network node; and wherein the user equipment is caused to: determine the reference signal or source reference signal indicated by the received transmission configuration indicator TCI state or Inter cell Beam Management ICBM indication; switch to the target network node; and monitor the determined reference signal receivable from the target network node by applying the determined reference signal for monitoring at least one downlink channel and optionally transmission of at least one uplink channel and wherein the user equipment is caused to consider it does not have an indicated transmission configuration indicator TCI state in relation to the target cell.

According to some embodiments, the received reference signal configuration associated with a reference signal receivable from one or more network node of the radio access network comprises a configuration of a reference signal receivable from a target network node; the user equipment is caused to communicate with the target cell using the received configuration of a reference signal receivable from a target network node, whilst leaving a serving cell unchanged; wherein the received mobility trigger indicating that the user equipment is to switch to the target network node includes a configuration of a reference signal receivable from the target network node; and wherein the user equipment is caused to: switch to the target network node; and monitor the reference signal receivable from the target network node in accordance with the configuration of the reference signal receivable from the target network node receivable from the target network node included in the received mobility trigger.

According to some embodiments, the user equipment is connected to a serving cell; the received reference signal configuration associated with a reference signal receivable from one or more network node of the radio access network comprises medium access control layer control element MAC CE message from the serving cell and comprises a transmission configuration indicator TCI state or Inter cell Beam Management ICBM indication relating to the target cell; the user equipment is caused to communicate with the target cell using the received transmission configuration indicator TCI state as a quasi co-located assumption for target cell monitoring whilst retaining the serving cell; wherein the received mobility trigger comprises a medium access control layer control element MAC CE message from the serving cell indicating that the user equipment is to switch to the target network node and includes a configuration of a reference signal receivable from the target network node in the form of a transmission configuration indicator TCI state or Quasi Co-located QCL source information relating to the target cell; and wherein the user equipment is caused to: determine a reference signal or source reference signal indicated by the transmission configuration indicator TCI state or Quasi Co-located QCL source information included in the received mobility trigger, overriding the previous transmission configuration indicator TCI state or Quasi Co-located QCL assumption; switch to the target network node; and monitor the reference signal receivable from the target network node by applying the determined reference signal for monitoring at least one downlink channel and optionally transmission of at least one uplink channel and wherein the user equipment is caused to consider it does not have an indicated transmission configuration indicator TCI state in relation to the target cell.

According to various, but not necessarily all, example embodiments there is provided: a method performed by user equipment of a radio access network; the method comprising: determining that the user equipment is configured to apply layer 1 or layer 2 triggered mobility; receiving a reference signal configuration associated with a reference signal receivable from one or more network node of the radio access network, wherein the configuration may comprise a configuration of a reference signal receivable from a target network node; receiving a mobility trigger indicating that the user equipment is to switch to the target network node, wherein the mobility trigger may include a configuration associated with a reference signal receivable from the target network node; switching to the target network node; assessing whether the mobility trigger or received reference signal configuration includes a configuration associated with a reference signal receivable from the target network node, and if so, monitoring the reference signal receivable from the target network node in accordance with the assessed associated configuration.

According to some embodiments, one of the one or more network node is a network node supporting the serving cell the user equipment is connected to.

According to some embodiments, the target network node is a network node supporting the target cell or target candidate cell. The target cell or target candidate sell may comprise a cell the user equipment is to switch to from a serving cell.

According to some embodiments, the network node supporting the serving cell and the network node supporting the target cell or target candidate cell are the same node or are different nodes, both nodes being physically co-located or not.

According to some embodiments, there is provided user equipment of a radio access network comprising: at least one processor; and at least one memory storing instructions that, when executed by the at least one processor, cause the user equipment to operate and perform steps as follows:

The user equipment may determine that the user equipment is configured to apply layer 1 or layer 2 triggered mobility. The determination may be based upon receipt of a configuration message or indication from the network. The configuration may comprise a Radio Resource Control RRC message. The message may be received from a serving cell or serving network node of the user equipment.

The user equipment may receive a reference signal configuration associated with a reference signal receivable from one or more network node of the radio access network. The reference signal configuration may be received at the user equipment. The reference signal configuration may be based upon receipt of a configuration message or indication from the network. The reference signal configuration may be based upon receipt of a configuration message or indication from a serving cell or serving network node of the user equipment. The receiving may comprise receiving a Radio Resource Control RRC message; or Medium Access Control (MAC) control element CE. The reference signal configuration may comprise any appropriate indication or mapping of a configuration of a reference signal. The reference signal configuration may, for example, comprise, for example, a transmission configuration indication (TCI) state, a quasi colocation QCL indication of a reference signal, a direct indication of a reference signal, or an Inter Cell Beam Management ICBM reference.

The received configuration may comprise: a configuration of a reference signal receivable from a target network node. The received configuration may comprise a configuration associated with the serving cell or network node. The received configuration may comprise a configuration associated with a cell other than the serving cell or target cell. The configuration may explicitly include a reference configuration associated with a serving cell of the user equipment, for example, TCI state, QCL, reference signal). The configuration may, or may not, further include an explicit reference configuration associated with a target cell and/or an implicit reference configuration associated with a target cell. Such an implicit reference may, for example, be in some way associated with a serving cell configuration.

The user equipment may receive a mobility trigger indicating that the user equipment is to switch to the target network node. The mobility trigger may be received at the user equipment. The mobility trigger may be based upon receipt of a configuration message or indication from the network. The mobility trigger may be based upon receipt of a configuration message or indication from a serving cell or serving network node of the user equipment. The mobility trigger may be sent as part of a MAC CE message sent from a serving network node to the UE, ie the serving network node supporting a serving cell to which the UE is connected, and may include or support functionality of a Distributed Unit (DU).

The mobility trigger may include a configuration associated with a reference signal receivable from the target network node. As described above, the received configuration may comprise: a configuration of a reference signal receivable from a target network node. The received configuration may comprise a configuration associated with the serving cell or network node. The received configuration may comprise a configuration associated with a cell other than the serving cell or target cell. The configuration may explicitly include a reference configuration associated with a serving cell of the user equipment, for example, TCI state, QCL, reference signal). The configuration may, or may not, further include an explicit reference configuration associated with a target cell and/or an implicit reference configuration associated with a target cell. Such an implicit reference may, for example, be in some way associated with a serving cell configuration.

The user equipment may switch to the target network node. Switching may, for example, include a handover from a serving cell to a target cell. Switching may, for example, comprise a UE performing for example, a random access procedure to perform the handover/switch to a target cell. Switching may occur without the user equipment performing a random access procedure to the target cell. Switching may be performed after assessing step, thus assessing may be performed before any such switching step.

The user equipment may assess whether the mobility trigger or received reference signal configuration includes a configuration associated with a reference signal receivable from the target network node.

In response to detecting the mobility trigger or the received reference signal configuration include a configuration associated or associable with a reference signal receivable from the target network node, the user equipment may be configured to monitor the reference signal receivable from the target network node in accordance with the detected associated configuration.

In response to detecting both the mobility trigger and the received reference signal configuration include a configuration associated or associable with a reference signal receivable from the target network node, the user equipment may pick the most recent received configuration, and the user equipment may then be configured to monitor the reference signal receivable from the target network node in accordance with the detected associated configuration.

In response to detecting that neither the mobility trigger nor the received reference signal configuration include a configuration associated or associable with a reference signal receivable from the target network node, the user equipment may be configured to perform a random access procedure towards the target mode.

The method may further comprise assuming that a reference signal configuration associated with a reference signal receivable from the target network node is unknown after the switch to the target network node. As an example, UE determines that it has not received or has not been indicated an indication of a TCI state (i.e. has not been indicated with a TCI state that is applied for communication e.g. DL/UL or both). As an example of a reference signal receivable from the target network node is unknown, it may refer to a case where UE has not been indicated with a TCI state and it applies the predetermined QCL information for transmission and/or reception of channels/signals.

According to some embodiments, the received reference signal configuration associated with a reference signal receivable from one or more network node of the radio access network comprises a Transmission Configuration Indicator state, and the configuration includes a Transmission Configuration Indicator state of a reference signal receivable from the target network node and wherein after the switch to the target network node, the user equipment is configured to not apply the Transmission Configuration Indicator state of the reference signal receivable from the target network node received prior to the switch to the target network node.

According to some embodiments, if the received reference signal configuration associated with a reference signal receivable from one or more network node of the radio access network includes a configuration of a reference signal receivable from a target network node, the user equipment is configured to: monitor the reference signal receivable from the target network node in accordance with the assessed associated configuration at least until the mobility trigger is received.

According to some embodiments, assessing whether the reference signal configuration associated with a reference signal or mobility trigger includes a configuration of a reference signal receivable from the target network node comprises: selecting the reference signal configuration associated with a reference signal receivable from the target network node received in the mobility trigger in preference to any reference signal configuration associated with a reference signal receivable from the target network node included in the reference signal configuration associated with a reference signal receivable from one or more network node of the radio access network.

According to some embodiments, if the user equipment assesses that neither the reference signal configuration associated with a reference signal receivable from one or more network node of the radio access network nor mobility trigger includes a reference signal configuration associated with a reference signal receivable from the target network node; the user equipment is configured to: initiate a random access request to the target network node indicated by the mobility trigger.

According to some embodiments, the method comprises monitoring the reference signal receivable from the target network node in accordance with the assessed associated configuration at least until an updated reference signal configuration associated with a reference signal receivable from one or more network node of the radio access network is received from the target network node.

According to some embodiments, monitoring the the reference signal receivable from the target network node in accordance with the assessed associated configuration comprises: monitoring at least one downlink channel received from the target network node based on the reference signal receivable from the target.

According to some embodiments, the method comprises performing a transmission based upon the assessed associated target cell configuration at least until an updated reference signal configuration associated with a reference signal receivable from one or more network node of the radio access network is received from the target network node.

According to some embodiments, the transmission comprises: transmitting at least one uplink channel based on the reference signal receivable from the target.

According to some embodiments, the reference signal configuration associated with a reference signal receivable from the target cell of the radio access network comprises at least one inter-cell beam management ICBM indicator.

According to some embodiments, the reference signal configuration associated with a reference signal receivable from one or more network node of the radio access network comprises at least one Transmission Configuration Indicator TCI state indicator.

According to some embodiments, the method comprises determining a downlink reference signal or quasi-co-located source reference signal in dependence upon a received Transmission Configuration Indicator state.

According to some embodiments, the user equipment is configured with at least one Transmission Configuration Indicator state which maps to a downlink reference signal index associated with the target network node.

According to some embodiments, the method comprises receiving a Transmission Configuration Indicator state index which maps reference signals to Transmission Configuration Indicator states, the index being determined by the network.

According to some embodiments, the mobility trigger comprises a switch command or switch parameter to be met in relation to the target network node.

According to some embodiments, the mobility trigger comprises a medium access control layer control element MAC-CE or downlink control information DCI receivable by the user equipment.

According to some embodiments, the mobility trigger comprises: a Transmission Configuration Indicator TCI state which maps to a reference signal index associated with the target network node.

According to some embodiments, the mobility trigger comprises: a downlink reference signal configuration associated with the target network node.

According to some embodiments, receiving a reference signal configuration associated with a reference signal receivable from one or more network node of the radio access network comprise: receiving at least one Transmission Configuration Indicator TCI state, and wherein the at least one configuration of a reference signal receivable from a target network node comprises a Transmission Configuration Indicator TCI state associated with a physical cell identity which differs from that of a serving cell of the user equipment; and wherein receiving a mobility trigger indicating that the user equipment is to switch to the target network node, wherein the mobility trigger is associated with a Transmission Configuration Indicator TCI state associated with the target network node; and wherein the user equipment is configured to: determine a downlink reference signal indicated by the Transmission Configuration Indicator TCI state or a quasi co-located source reference signal of the reference signal indicated by the Transmission Configuration Indicator TCI state without mapping the Transmission Configuration Indicator TCI state to the target cell configuration; switch to the target network node; apply the determined downlink reference signal for monitoring at least one downlink channel and optionally transmission of at least one uplink channel; and assess that the user equipment does not have a Transmission Configuration Indicator TCI state in relation to the target cell, and applied at least one rule for a quasi co-located QCL assumption based on the applied reference signal.

According to some embodiments, for a CORESET other than a CORESET with index 0, if the user equipment has not been provided with a configuration of Transmission Configuration Indicator state(s) by: tci-StatesPDCCH-ToAddList and tci-StatesPDCCH-ToReleaseList for the CORESET; or has been provided initial configuration of more than one Transmission Configuration Indicator TCI states for the CORESET by tci-StatesPDCCH-ToAddList and tci-StatesPDCCH-ToReleaseList but has not received a MAC CE activation command for one of the TCI states;

the user equipment is configured to: assume that a demodulation reference signal DM-RS antenna port associated with Physical Downlink Control Channel PDCCH reception is quasi co-located with a Synchronisation Signal/Physical Broadcast Channel SS/PBCH block as identified by the user equipment for a most recently received Channel Status Information Reference Signal CSI-RS configured with Tracking Reference Signal TRS-info or a Synchronisation Signal Block SSB associated with a Physical Cell Identity PCI other than a serving cell provided to the user equipment indicated by determined Transmission Configuration Indicator TCI information; or optionally for the most recent Channel Status Information Reference Signal CSI-RS or Synchronisation Signal Block SSB index provided to the user equipment by a received configuration index provided by the mobility trigger or determination that the user equipment is configured to apply layer 1 or layer 2 triggered mobility as part of a Layer1/layer 2 triggered mobility LTM trigger command or an equivalent message triggering cell switch to a new target cell; or optionally for the most recent Channel Status Information Reference Signal CSI-RS or Synchronisation Signal Block SSB index provided to user equipment by the mobility trigger or determination that the user equipment is configured to apply layer 1 or layer 2 triggered mobility as part of a Layer1/layer 2 triggered mobility LTM trigger command from the user equipment serving cell indicated by a configuration index or in any message triggering cell switch to the target cell.

According to some embodiments, the received reference signal configuration associated with a reference signal receivable from one or more network node of the radio access network does not comprise a configuration of a reference signal receivable from a target network node; and the received mobility trigger indicating that the user equipment is to switch to the target network node does include a configuration of a reference signal receivable from the target network node; and wherein the user equipment is caused to: switch to the target network node; and monitor the reference signal receivable from the target network node in accordance with the configuration of the reference signal receivable from the target network node included in the received mobility trigger.

According to some embodiments, the user equipment is connected to a serving cell; wherein the received reference signal configuration associated with a reference signal receivable from one or more network node of the radio access network is received from the serving cell and does not comprise a configuration of a reference signal receivable from a target network node; wherein the received mobility trigger comprises a medium access control layer control element MAC CE message from the serving cell indicating that the user equipment is to switch to the target network node and includes a configuration of a reference signal receivable from the target network node in the form of a transmission configuration indicator TCI state or Quasi Co-located QCL source information relating to the target cell; and wherein the user equipment is caused to: determine a reference signal or source reference signal indicated by the TCI state or Quasi Co-located QCL source information; switch to the target network node; and monitor the reference signal receivable from the target network node by applying the determined reference signal for monitoring at least one downlink channel and optionally transmission of at least one uplink channel and wherein the user equipment is caused to consider it does not have an indicated transmission configuration indicator TCI state in relation to the target cell.

According to some embodiments, the received reference signal configuration associated with a reference signal receivable from one or more network node of the radio access network does not comprise a configuration of a reference signal receivable from a target network node; and the received mobility trigger indicating that the user equipment is to switch to the target network node does not include a configuration of a reference signal receivable from the target network node; and wherein the user equipment is caused to: determine that it is to switch to the target network node; and initiate a random access request to the target cell.

According to some embodiments, the user equipment is connected to a serving cell; the received reference signal configuration associated with a reference signal receivable from one or more network node of the radio access network is received from the serving cell and does not comprise a configuration of a reference signal receivable from a target network node; and the received mobility trigger comprises a medium access control layer control element MAC CE message from the serving cell indicating that the user equipment is to switch to the target network node and does not include a configuration of a reference signal receivable from the target network node; and wherein the user equipment is caused to: determine that it is to switch to the target network node; and initiate a contention based random access request to the target cell.

According to some embodiments, the received reference signal configuration associated with a reference signal receivable from one or more network node of the radio access network comprises a configuration of a reference signal receivable from a target network node; and the received mobility trigger indicating that the user equipment is to switch to the target network node does not include a configuration of a reference signal receivable from the target network node; and wherein the user equipment is caused to: switch to the target network node; and monitor the reference signal receivable from the target network node in accordance with the configuration of the reference signal receivable from the target network node included in the received reference signal configuration associated with a reference signal receivable from one or more network node of the radio access network.

According to some embodiments, the user equipment is connected to a serving cell; the received reference signal configuration associated with a reference signal receivable from one or more network node of the radio access network comprises medium access control layer control element MAC CE message from the serving cell and comprises a transmission configuration indicator TCI state or Inter cell Beam Management ICBM indication relating to the target cell; and the received mobility trigger comprises a medium access control layer control element MAC CE message from the serving cell indicating that the user equipment is to switch to the target network node, wherein the received mobility trigger does not include a configuration of a reference signal receivable from the target network node; and wherein the user equipment is caused to: determine the reference signal or source reference signal indicated by the received transmission configuration indicator TCI state or Inter cell Beam Management ICBM indication; switch to the target network node; and monitor the determined reference signal receivable from the target network node by applying the determined reference signal for monitoring at least one downlink channel and optionally transmission of at least one uplink channel and wherein the user equipment is caused to consider it does not have an indicated transmission configuration indicator TCI state in relation to the target cell.

According to some embodiments, the received reference signal configuration associated with a reference signal receivable from one or more network node of the radio access network comprises a configuration of a reference signal receivable from a target network node; the user equipment is caused to communicate with the target cell using the received configuration of a reference signal receivable from a target network node, whilst leaving a serving cell unchanged; wherein the received mobility trigger indicating that the user equipment is to switch to the target network node includes a configuration of a reference signal receivable from the target network node; and wherein the user equipment is caused to: switch to the target network node; and monitor the reference signal receivable from the target network node in accordance with the configuration of the reference signal receivable from the target network node receivable from the target network node included in the received mobility trigger.

According to some embodiments, the user equipment is connected to a serving cell; the received reference signal configuration associated with a reference signal receivable from one or more network node of the radio access network comprises medium access control layer control element MAC CE message from the serving cell and comprises a transmission configuration indicator TCI state or Inter cell Beam Management ICBM indication relating to the target cell; the user equipment is caused to communicate with the target cell using the received transmission configuration indicator TCI state as a quasi colocated assumption for target cell monitoring whilst retaining the serving cell; wherein the received mobility trigger comprises a medium access control layer control element MAC CE message from the serving cell indicating that the user equipment is to switch to the target network node and includes a configuration of a reference signal receivable from the target network node in the form of a transmission configuration indicator TCI state or Quasi Co-located QCL source information relating to the target cell; and wherein the user equipment is caused to: determine a reference signal or source reference signal indicated by the transmission configuration indicator TCI state or Quasi Co-located QCL source information included in the received mobility trigger, overriding the previous transmission configuration indicator TCI state or Quasi Co-located QCL assumption; switch to the target network node; and monitor the reference signal receivable from the target network node by applying the determined reference signal for monitoring at least one downlink channel and optionally transmission of at least one uplink channel and wherein the user equipment is caused to consider it does not have an indicated transmission configuration indicator TCI state in relation to the target cell.

According to various, but not necessarily all, example embodiments there is provided a computer program product operable, when executed on a computer, to perform the method of: determining that the user equipment is configured to apply layer 1 or layer 2 triggered mobility; receiving a reference signal configuration associated with a reference signal receivable from one or more network node of the radio access network, wherein the configuration may comprise a configuration of a reference signal receivable from a target network node; receiving a mobility trigger indicating that the user equipment is to switch to the target network node, wherein the mobility trigger may include a configuration associated with a reference signal receivable from the target network node; switching to the target network node; assessing whether the mobility trigger or received reference signal configuration includes a configuration associated with a reference signal receivable from the target network node, and if so, monitoring the reference signal receivable from the target network node in accordance with the assessed associated configuration.

According to various, but not necessarily all, example embodiments there is provided a network node of a radio access network comprising: at least one processor; and at least one memory storing instructions that, when executed by the at least one processor, cause the user equipment at least to: determine that a user equipment is configured to apply layer 1 or layer 2 triggered mobility; provide to the user equipment a reference signal configuration associated with a reference signal receivable from one or more network node of the radio access network, wherein the configuration may comprise an configuration of a reference signal receivable from a target network node; provide a mobility trigger to the user equipment indicating that the user equipment is to switch to the target network node, wherein the mobility trigger may include a configuration associated with a reference signal receivable from the target network node.

According to various, but not necessarily all, example embodiments there is provided a method performed by a network node of a radio access network; the method comprising: determining that a user equipment is configured to apply layer 1 or layer 2 triggered mobility; providing to the user equipment a reference signal configuration associated with a reference signal receivable from one or more network node of the radio access network, wherein the configuration may include an configuration of a reference signal receivable from a target network node; providing a mobility trigger to the user equipment indicating that the user equipment is to switch to the target network node, wherein the mobility trigger may include a configuration associated with a reference signal receivable from the target network node.

According to various, but not necessarily all, example embodiments there is provided a computer program product operable, when executed on a computer, to perform a method comprising: determining that a user equipment is configured to apply layer 1 or layer 2 triggered mobility; providing to the user equipment a reference signal configuration associated with a reference signal receivable from one or more network node of the radio access network, wherein the configuration may include an configuration of a reference signal receivable from a target network node; providing a mobility trigger to the user equipment indicating that the user equipment is to switch to the target network node, wherein the mobility trigger may include a configuration associated with a reference signal receivable from the target network node

Aspects and embodiments relate to mechanisms and procedures used in support of Layer 1/Layer 2 (L1/L2) triggered inter-cell mobility (LTM). Aspects and embodiments may provide mechanisms and procedures relating to L1/L2 based inter-cell mobility which support a reduction of mobility latency. Some aspects and embodiments described provide Medium Access Control (MAC) control signalling, for example, a MAC Control Element (CE) which may indicate Transmission Configuration Indicator (TCI) state(s) (or other beam info) to activate at a UE in relation to a mobility target cell(s).

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION

Some example embodiments will now be described with reference to the accompanying drawings in which:

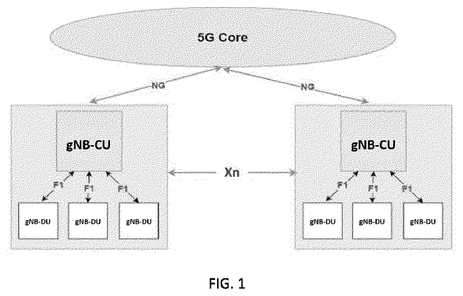

FIG. 1 illustrates schematically some main components of a 5G new radio NR wireless communication network;

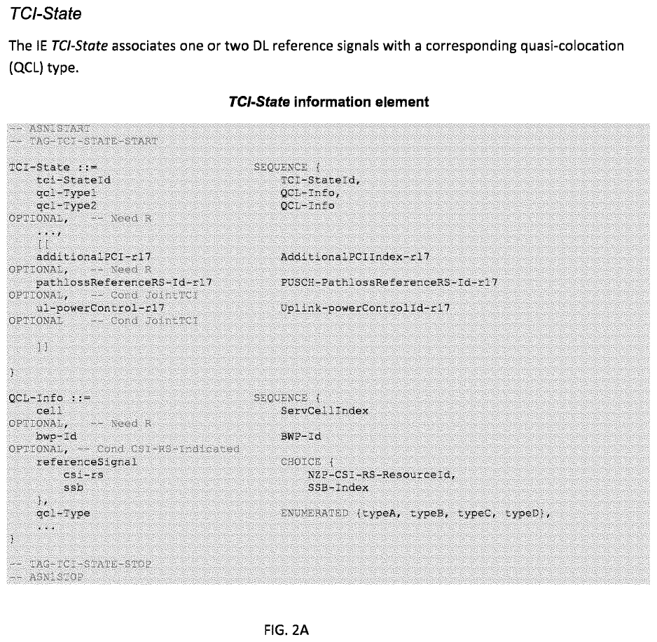

FIGS. 2A and 2B illustrates a form of a Transmission Configuration Indicator (TCI) state information element;

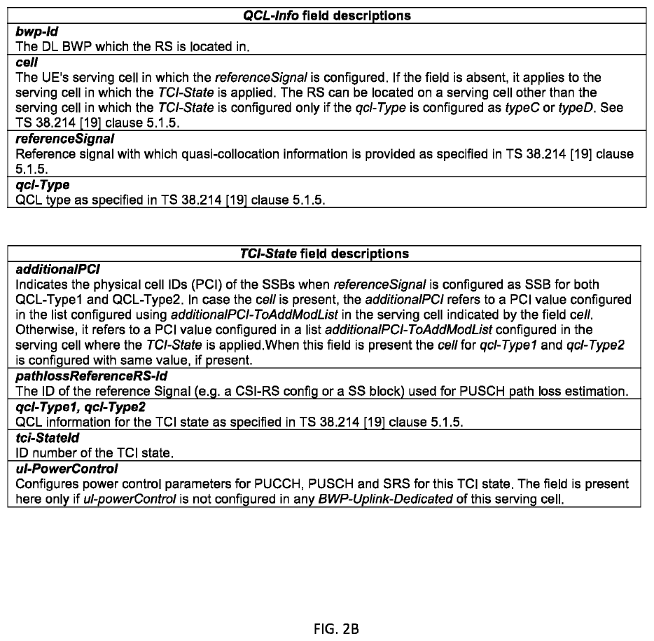

FIG. 3 is a signalling diagram illustrating signalling in support of one possible implementation;

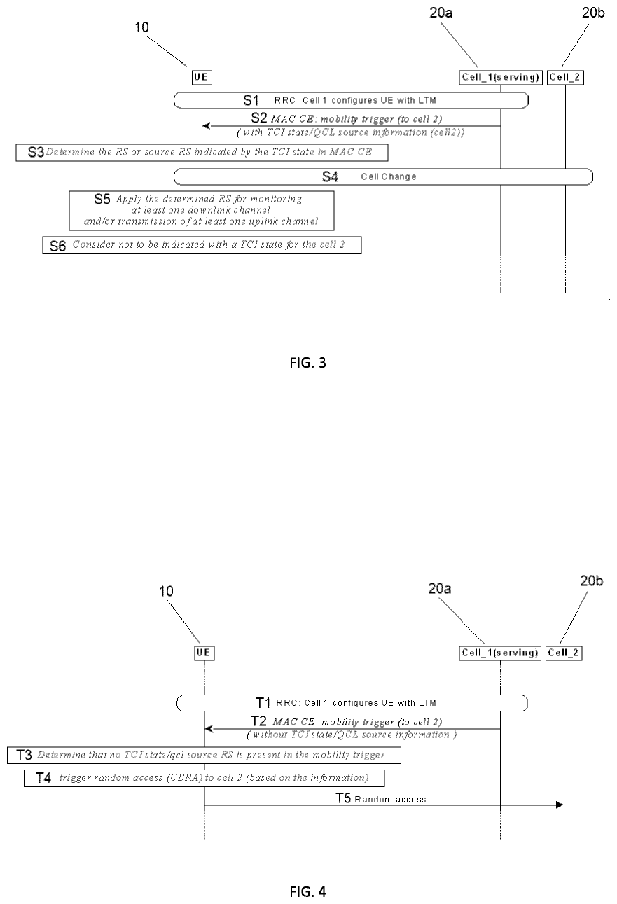

FIG. 4 is a signalling diagram illustrating signalling in support of one possible implementation;

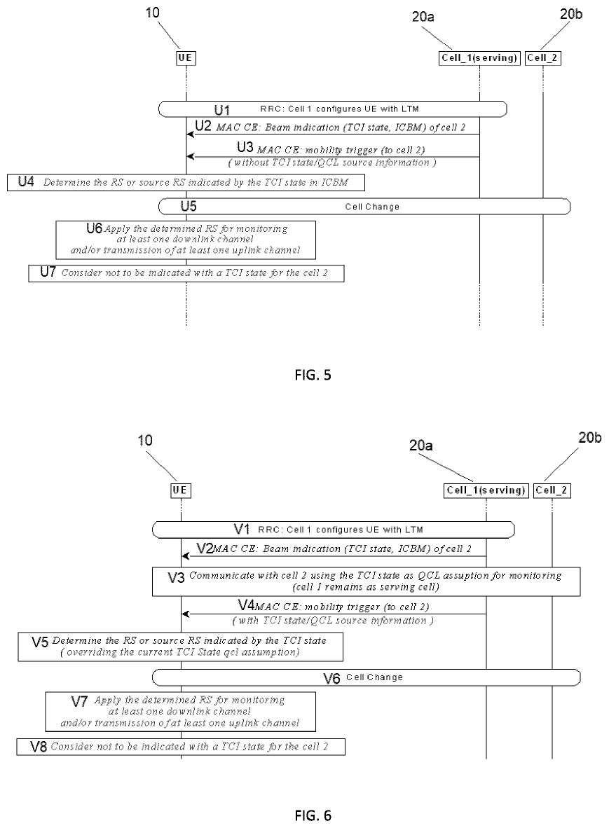

FIG. 5 is a signalling diagram illustrating signalling in support of one possible implementation;

FIG. 6 is a signalling diagram illustrating signalling in support of one possible implementation; and

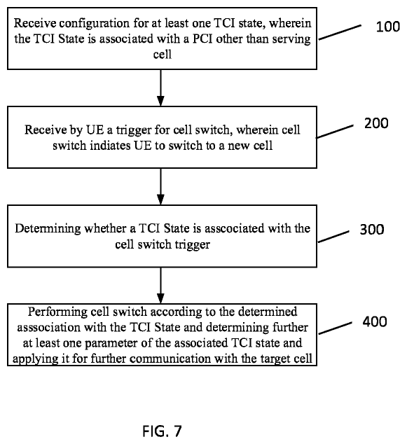

FIG. 7 is a flowchart illustrating schematically steps according to one arrangement;

### DETAILED DESCRIPTION

Before discussing the example embodiments in any more detail, first a general framework of a wireless communication network is described, in which context an overview of arrangements will be provided.

The concepts presented may be implemented across a broad variety of telecommunication systems, network architectures, and communication standards. Various aspects are described generally with reference to a wireless communication system. Such a wireless communication system typically includes three interacting domains: a core network, a radio access network (RAN), and user equipment (UE).

The RAN may be configured to implement any suitable wireless communication technology (or combination of technologies) to provide radio access to UE. According to one example, the RAN may be configured to operate according to the 3rd Generation Partnership Project (3GPP) New Radio (NR) specifications, typically referred to as 5G.

As user equipment (UE) moves through a wireless communication system, it may move through regions of radio coverage (cells) supported by one or more radio access network node. Maintaining an ability for UE to communicate effectively with the wireless communication system as it moves through regions of radio coverage is typically referred to as mobility. The operational characteristics of cells supported by network access nodes within a wireless communication network may differ. The wireless communication system may comprise various Ttransmission and Reception Points (TRPs).

FIG. 1A illustrates schematically some main components of a 5G New Radio (NR) network topology. It is envisaged that multiple transmission and reception points mTRPs will be used in a 5G NR network to improve reliability, coverage and capacity performance through flexible deployment scenarios. Multi-TRP operates to alleviate intercell interference via dynamic coordination between multi TRPs to provide joint scheduling and transmission/reception. Typically wireless devices, such as UEm at a cell edge may be served by multi TRPs ro improve signal transmission and/or reception, resulting in increased throughput. The following description may provide further details of alternatives, modifications and variances in a 5G NR network: a gNB comprises e.g. a node providing NR user plane and control plane protocol terminations towards the UE, and connected via the NG interface to the 5GC, e.g. according to 3GPP TS 38.300 V16.6.0(2021-06) section 3.2 incorporated by reference.

A gNB Central Unit (gNB-CU) comprises e.g. a logical node hosting e.g. RRC (radio resource control), SDAP (service data adaptation protocol) and PDCP (packet data convergence protocol) protocols of the gNB or RRC and PDCP protocols of the en-gNB that controls the operation of one or more gNB-DUs. The gNB-CU terminates the F1 interface connected with the gNB-DU.

A gNB Distributed Unit (gNB-DU) comprises e.g. a logical node hosting e.g. RLC (radio link control), MAC (medium access control) and PHY (physical) layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

A gNB-CU-Control Plane (gNB-CU-CP) comprises e.g. a logical node hosting e.g. the RRC and the control plane part of the PDCP protocol of the gNB-CU for an en-gNB or a gNB. The gNB-CU-CP terminates the E1 interface connected with the gNB-CU-UP and the F1-C interface connected with the gNB-DU.

A gNB-CU-User Plane (gNB-CU-UP) comprises e.g. a logical node hosting e.g. the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU, e.g. according to 3GPP TS 38.401 V16.6.0 (2021-07) section 3.1 incorporated by reference.

Different functional splits between the central and distributed unit are possible, e.g. called options:

Option 1 (1A-like split):
The function split in this option is similar to the 1A architecture in DC. RRC is in the central unit. PDCP, RLC, MAC, physical layer and RF are in the distributed unit.
   Option 2 (3C-like split):
The function split in this option is similar to the 3C architecture in DC. RRC and PDCP are in the central unit. RLC, MAC, physical layer and RF are in the distributed unit.
   Option 3 (intra RLC split):
Low RLC (partial function of RLC), MAC, physical layer and RF are in the distributed unit. PDCP and high RLC (the other partial function of RLC) are in the central unit.
   Option 4 (RLC-MAC split):
MAC, physical layer and RF are in the distributed unit. PDCP and RLC are in the central unit.

Or else, e.g. according to 3GPP TR 38.801 V14.0.0(2017-03) section 11 incorporated by reference.

A gNB supports different protocol layers, e.g. Layer 1 (L1)-physical layer.

The layer 2 (L2) of NR is split into the following sublayers: Medium Access Control (MAC), Radio Link Control (RLC), Packet Data Convergence Protocol (PDCP) and Service Data Adaptation Protocol (SDAP), where e.g.:

The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC QoS flows;
Comp. refers to header compression and Segm. to segmentation;
Control channels include (BCCH, PCCH).

Layer 3 (L 3) includes e.g. Radio Resource Control (RRC), e.g. according to 3GPP TS 38.300 V16.6.0(2021-06) section 6 incorporated by reference.

A RAN (Radio Access Network) node or network node or central node or distributed node like e.g. a gNB, base station, gNB CU or gNB DU or parts thereof may be implemented using e.g. an apparatus with at least one processor and/or at least one memory (with computer-readable instructions (computer program)) configured to support and/or provision and/or process CU and/or DU related functionality and/or features, and/or at least one protocol (sub-)layer of a RAN (Radio Access Network), e.g. layer 2 and/or layer 3. They may also be implemented using specific means configured to perform respective specific tasks, e.g. layer 3 means to perform layer 3 operations, layer 2 means to perform layer 2 operations, etc. A central node may e.g. implement CU-CP and/or CP-UP functionality.

The gNB CU and gNB DU parts may e.g. be co-located or physically separated. The gNB DU may even be split further, e.g. into two parts, e.g. one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof.

A gNB-DU supports one or multiple cells, and could thus serve as e.g. a serving cell for a user equipment (UE).

In other words: A 5G base station or “network node” named gNB can be divided into two physical entities named CU (Centralized Unit) and DU (Distributed Unit).

CU provides support for the higher layers of the protocol stack such as SDAP, PDCP and RRC (and in particular layer 3 protocol like RRC) while DU provides support for the lower layers of the protocol stack such as RLC, MAC and Physical layer (in particular layer 1 like Physical layer and layer 2 protocol like RLC and MAC). Also, note that SDAP layer will not be present if the CU is connected to a 4G Core network as we should have 5G core network to support SDAP. Practically speaking, there is a single CU for each gNB, but one CU controls multiple DUs, for example more than 100 DUs can be connected to one CU.

Each DU is able to support one or more cells, so one gNB can control hundreds of cells unlike a 4G base station. Also, note that the interface between CU and DU is named F1 and as per 3GPP, it should be an open interface, so you connect one CU from vendor X to another DU from vendor Y.

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g. configured to generate a message (e.g. including a cell ID) to be transmitted via radio towards a RAN (e.g. to reach and communicate with a serving cell). A UE may generate and transmit and receive RRC messages containing one or more RRC PDUs (Packet Data Units).

The UE may have different states (e.g. according to 3GPP TS 38.331 V16.5.0(2021-06) sections 42.1 and 4.4, incorporated by reference).

A UE is e.g. either in RRC_CONNECTED state or in RRC_INACTIVE state when an RRC connection has been established.

In RRC_CONNECTED state a UE may:

store the AS context;
transfer unicast data to/from the UE;
monitor control channels associated with the shared data channel to determine if data is scheduled for the data channel;
provide channel quality and feedback information;
perform neighboring cell measurements and measurement reporting;

The RRC protocol includes e.g. the following main functions:
RRC connection control;
measurement configuration and reporting;
establishment/modification/release of measurement configuration (e.g. intra-frequency, inter-frequency and inter-RAT measurements);
setup and release of measurement gaps;
measurement reporting.

As networks have developed, and particularly in 5G New Radio (NR) systems, rather than being controlled by the core network, inter-cell mobility is implemented such that it is configured to be layer 1 (L1 or PHY layer) or layer 2 (L2 or MAC layer) centric (L1/L2-centric). Within the 5G NR framework, various methodologies to implement L1/L2-centric inter-cell mobility are possible, and may be selected based upon varying operational scenarios as described further below.

Various arrangements directed towards support of L1/L2-Centric Inter-Cell Mobility methodologies and signalling are described. The arrangements described recognise various complexities associated with supporting mobility of UE operating in a RAN where a serving or source cell may have a configuration which potentially significantly differs from a configuration associated with one or more candidate serving cell(s).

In order to reduce mobility latency, in the 3GPP Rel-18 Working Item Description (WID) on Further NR mobility enhancements, RP-222332, one of the objectives was agreed relating to the specification of mechanisms and procedures of Layer 1/Layer 2 (L1/L2) triggered inter-cell mobility (LTM) including the following items:
1. To specify mechanism and procedures of L1/L2 based inter-cell mobility for mobility latency reduction:
   Configuration and maintenance for multiple candidate cells to allow fast application of configurations for candidate cells [RAN2, RAN3]
   Dynamic switch mechanism among candidate serving cells (including SpCell and SCell) for the potential applicable scenarios based on L1/L2 signalling [RAN2, RAN1]
   L1 enhancements for inter-cell beam management, including L1 measurement and reporting, and beam indication [RAN1, RAN2]

Note 1: Early RAN2 involvement is necessary, including the possibility of further clarifying the interaction between this bullet with the previous bullet
Timing Advance management [RAN1, RAN2]
CU-DU interface signaling to support L1/L2 mobility, if needed [RAN3]

Note 2: FR2 specific enhancements are not precluded, if any.

Note 3: The procedure of L1/L2 based inter-cell mobility are applicable to the following scenarios:
Standalone, CA and NR-DC case with serving cell change within one CG
Intra-DU case and intra-CU inter-DU case (applicable for Standalone and CA: no new RAN interfaces are expected)
Both intra-frequency and inter-frequency
Both FR1 and FR2
Source and target cells may be synchronized or non-synchronized

RAN2 has agreed the following in RAN2 #119bis:

The following relevant agreements were made in RAN2 #119b:

RAN2 assumes that whether to use the unified TCI framework as the baseline for beam indication for L1/L2 mobility is up to RAN1 (RAN2 observes that L1/L2 mobility need to support inter-frequency cases).

A L1/L2 inter-cell mobility candidate (target) configuration is received within an RRC message before the L1/L2 dynamic switch is triggered.

RAN2 assumes L1/2 mobility trigger information is conveyed in a MAC CE. It is for further study as to whether a MAC CE message or a Downlink Control Information (DCI) message is used for actual triggering of a mobility event.

RAN2 assumes the MAC CE for L1/2 mobility trigger contains at least a candidate configuration index. It is for further study as to whether the MAC CE can indicate TCI state(s) (or other beam info) to a UE allowing activation for the target Cell(s).

RAN1 (in RAN1 #110-bis) has agreed to study further the following:
RAN1 to further study whether the beam indication of candidate cell(s) L1/L2 mobility should be designed for a specific TCI framework below, and their potential RAN1 spec impact.
   Option A: Beam indication for Rel-18 L1/L2 mobility is designed based on Rel-17 TCI framework mechanism
   Option B: Beam indication for Rel-18 L1/L2 mobility is designed based on Rel-15 TCI framework mechanism
   Option C: Beam indication for Rel-18 L1/L2 mobility is designed based on both Rel-15 and Rel-17 TCI framework mechanisms

### Transmission Configuration Indicator (TCI) States

Information about reference signal(s) receivable by a UE from network access nodes may be provided to the UE in TCI state signaling. A Transmission Configuration Indicator (TCI) can be dynamically sent to a UE in downlink control signalling (for example DCI messaging) and the TCI state may comprise information, for example, configurations such as QCL-relationships between Downlink (DL) reference signals (RS) in one channel Status Information Reference Signal (CSI-RS) set and Physical Downlink Shared Channel (PDSCH) demodulation reference signal (DMRS) ports.

3GPP TS 38.331 sets out the general form of a TCI-state information provided within a network, details of which are illustrated in FIG. 2A and FIG. 2B.

A UE can typically be configured with a list of up to “M” TCI-State configurations within the higher layer (RRC ReConfig) parameter PDSCH-Config to decode PDSCH according to a detected PDCCH with DCI intended for the UE and a given serving cell. M depends on UE capability.

Each TCI-State comprises parameters relating to a quasi co-location relationship between one or two downlink reference signals. Furthermore, each TCI-State contains parameters for configuring a quasi co-location relationship between one or two downlink reference signals and the DM-RS ports of the PDSCH, the DM-RS port of PDCCH or the CSI-RS port(s) of a CSI-RS resource. As a result, TCI information already provided to UE typically includes Quasi-Colocation (QCL) Information. Two signals transmitted from the same antenna port typically experience the same radio channel. Two signals transmitted from two different antenna ports typically experience different radio conditions. It is accepted that there can be cases where signals transmitted from two different antenna ports experience radio channels having common properties. In such cases the antenna ports are said to be Quasi-Co-located (QCL).

The definitions of the QCL types are provided in TS 38.214 and the four types indicate which large scale channel properties are common across sets of antenna ports.
‘typeA’: {Doppler shift, Doppler spread, average delay, delay spread}
‘typeB’: {Doppler shift, Doppler spread}
‘typeC’: {Doppler shift, average delay}
‘typeD’: {Spatial Rx parameter}

QCL information provided in the TCI may comprise:
1) the Reference Signal (RS);
2) QCL type=typeA, typeB, typeC and typeD; and
3) a bandwidth part (bwp) which the RS is located.

The TCI information and QCL information may be utilized in implementing mechanisms and signalling for support of mobility within a network.

For example, it is set out that for switching the serving beam, one of the following options are allowed for QCL-info:
(1) qcl-Type1: referenceSignal=Tracking RS (TRS) index where TRS is a special configuration of CSI-RS index (see below) and qcl-Type=A, qcl-Type2 (applicable only in FR2): referenceSignal=same TRS index and qcl-Type=D.
(2) qcl-Type1: referenceSignal=Tracking RS (TRS) index and qcl-Type=A, qcl-Type2 (applicable only in FR2): referenceSignal=CSI-RS index with repetition and qcl-Type=D.

### Unified TCI State Framework and R18 Extension

The R17 unified TCI state framework is used as a baseline for R18 S-DCI and m-DCI multiple-TRP transmission enhancements for UL multipanel transmission. In unified TCI State (Rel17) framework, a single TCI state can be indicated to UE and this TCI state or rather RS(s) indicated by the TCI State are used for transmission and reception assumptions for PDCCH/PDSCH/CSI-RS and/or PUCCH/PUSCH/SRS.

In unified TCI state framework, the beam indication or rather TCI state indication (i.e. indication which TCI state is used for transmission and/or reception assumptions for signals and channels associated with the TCI State) has following steps:
1. For a serving cell, the unified TCI State type is configured to be either joint UL/DL or separate UL/DL. In joint UL/DL the indicated TCI State is used for uplink and downlink, and in separate the DL and UL are indicated separately (one TCI codepoint that is indicated in DCI may comprise DL TCI only, UL TCI only or DL and UL TCI states). If the TCI state type is joint, UE is configured with a single list of TCI states using RRC (dl-OrJoint-TCIStateList).
2. If the TCI state type is separate, UE is configured with a DL TCI State list and UL TCI State list (dl-OrJoint-TCIStateList, ul-TCI-StateList). Configuration is done using RRC signaling while MAC CE selects and activates up to eight (in Rel-17) TCI codepoints of which one may become indicated via DCI. As said earlier, one TCI codepoint may comprise DL TCI state only, UL TCI state only or both DL and UL TCI states.
3. To indicate a TCI state (joint) or separate TCI States (UL and DL) network provides a TCI codepoint (a value in a DCI message) that corresponds to the TCI codepoint in the MAC CE that activated the TCI codepoint(s). Upon receiving the DCI based beam indication (a DCI codepoint) UE applies the indicated TCI States for the indicated channels (PDSCH, PCCH/PUSCH/PUCC)

After a UE receives an initial higher layer configuration of dl-OrJoint-TCIStateList with more than one TCIState and before application of an indicated TCI state from the configured TCI states:
The UE assumes that DM-RS of PDSCH and DM-RS of PDCCH and the CSI-RS applying the indicated TCI state are quasi co-located with the SS/PBCH block the UE identified during the initial access procedure

After a UE receives a higher layer configuration of dl-OrJoint-TCIStateList with more than one TCIState as part of a Reconfiguration with sync procedure as described in [12, TS 38.331] and before applying an indicated TCI state from the configured TCI states:
The UE assumes that DM-RS of PDSCH and DM-RS of PDCCH, and the CSI-RS applying the indicated TCI state are quasi co-located with the SS/PBCH block or the CSI-RS resource the UE identified during the random access procedure initiated by the Reconfiguration with sync procedure as described in [12, TS 38.331].

### Beam Level Mobility

3GPP TS 38.300 v17.2.0 (2022-09) provides as follows:
“9.2.3 Mobility in RRC_CONNECTED
Overview

Network controlled mobility applies to UEs in RRC_CONNECTED and is categorized into two types of mobility: cell level mobility and beam level mobility. Beam level mobility includes intra-cell beam level mobility and inter-cell beam level mobility.

Beam Level Mobility does not require explicit RRC signalling to be triggered. Beam level mobility can be within a cell, or between cells, the latter is referred to as inter-cell beam management (ICBM). For ICBM, a UE can receive or transmit UE dedicated channels/signals via a TRP associated with a PCI different from the PCI of a serving cell, while non-UE-dedicated channels/signals can only be received via a TRP associated with a PCI of the serving cell. The gNB provides via RRC signalling the UE with measurement configuration containing configurations of SSB/CSI resources and resource sets, reports and trigger states for triggering channel and interference measurements and reports. In case of ICBM, a measurement configuration includes SSB resources associated with PCIs different from the PCI of a serving cell. Beam Level Mobility is then dealt with at lower layers by means of physical layer and MAC layer control signalling, and RRC is not required to know which beam is being used at a given point in time.

SSB-based Beam Level Mobility is based on the SSB associated to the initial DL BWP and can only be configured for the initial DL BWPs and for DL BWPs containing the SSB associated to the initial DL BWP. For other DL BWPs, Beam Level Mobility can only be performed based on CSI-RS.

### Mobility Events

As can be understood in relation to the information provided above, in order to effectively implement L1/L2 triggered mobility within a network, information provided to a UE relating to beam(s) of candidate cell(s) may need addressing. In particular, beam indication of candidate cell(s) in Rel-18 L1/L2 triggered mobility (LTM) may need clarification. There may, for example, be different TCI state frameworks that have to be accommodated. It may, for example, be common for a UE to operate within a network in which different cells are configured with different TCI frameworks (for example, Rel-15 or Rel-17 TCI frameworks) and such a situation may particularly occur in, for example, inter-gNB mobility scenarios. It is possible that a single TCI framework may not be able to be used for beam indication if a target cell tries to interpret an indicated TCI state based on its own (target cell) incompatible configured TCI state pool/list.

Nonetheless, arrangements recognise that it may be possible to leverage information provided by a TCI state indicator in a beam management framework for Rel-18 LTM based cell switch using MAC CE and/or DCI-based mobility trigger indications. Arrangements described include a discussion of UE behaviour upon receiving specific information as part of (or associated with) a mobility trigger on the basis of which a UE is configured to switch to communication with a new cell.

Arrangements recognise that mechanisms which may be adopted for serving cell beam management may not be well suited to cases where lower layer triggered mobility is operational. In particular, serving cell beam management mechanisms may not capture any TCI State indication for lower layer triggered mobility where the serving cell changes.

Arrangements described in more detail below may provide specific implementations and mechanisms according to which UE is configured to receive TCI state indication which relates to a new target cell. Such an indication is provided to the UE by the serving cell. Arrangements and implementations described set out how a UE may be configured to useful apply such provided TCI state information when, for example, the UE receives the TCI state before a mobility trigger or as a part of a mobility trigger message.

Arrangements recognise that by using serving cell communication it is possible to provide a UE with information about a target cell, for example, via a TCI state. The UE may be configured such that, once it receives a mobility trigger relating to that target cell, it may consider the (indicated/applied) TCI State of that target cell to be essentially unknown (i.e. not indicated), or not specifically set (i.e. not indicated), yet still leverage the information provided by the serving cell in relation to that target cell. Such an approach has benefits in relation to support of mobility scenarios since the beam management framework for the target cell does not need to be the same as in the source cell (i.e. the beam indication framework can be R17 in source cell and R15 in target cell and the mobility still works). Furthermore, a UE does not need to be specifically indicated a TCI state that is applied for the target cell (in target cell configuration) before the mobility trigger, thus allowing a reduction in latency in relation to a mobility event.

Before discussing the example embodiments in any more detail, first an overview will be provided.

Arrangements and implementations may provide user equipment for use in a wireless communication network. The user equipment may receive an indication that the user equipment is configured to support layer 1 or layer 2 triggered mobility. In other words, the UE may support LTM mobility procedures. In accordance with arrangements, the user equipment may be configured to receive an indication of a reference signal configuration receivable from one or more network node of the radio access network. In accordance with some arrangements, the user equipment may be configured to receive a reference signal configuration receivable from one or more network node of the radio access network. The indication may include an indication of a reference signal configuration receivable from a target network node (the indication may comprise a mapping to a downlink (DL) Reference Signal (RS), such as, for example, a synchronization signal block (SSB)). The indication may include an indication of a configured reference signal (for example, the indication may comprise a TCI) receivable from a target network node. As an example, the indication may comprise an indication to user equipment to apply an indicated reference signal (a TCI State) for monitoring/reception and/or transmission of at least one of downlink and/or uplink channel. Typically, a user equipment receives an indication of one or more reference signals which are receivable from a serving network node, but similar information regarding monitorable reference signal(s) which may be transmitted by one or more other network nodes may be less apparent to the user equipment. The user equipment may receive a mobility trigger indicating that the user equipment is to switch to the target network node. In other words, the user equipment may determine, or be ordered, to be handed over to a cell supported by the target network node. The mobility trigger may include an indication of a reference signal receivable from the target network node. The user equipment may be configured to switch to the target network node. The user equipment may be configured to assess whether the indication of a reference signal or mobility trigger includes an indication of a reference signal receivable from the target network node, and if so, there user equipment may be configured to monitor the reference signal receivable from the target network node.

In one example, the mobility trigger may include an indication (for example, a bit field) to indicate whether the mobility trigger (which may, for example, comprise a Medium Access Control (MAC) Control Element (CE) or Downlink Control Indicator (DCI)) includes an indication of a reference signal receivable from the target network node.

The indication of reference signal receivable from the target network node may, for example, comprise an appropriate mapping, for example, a TCI state or a (QCL source) to a Downlink Reference Signal (DL RS). The Downlink Reference Signal may, for example, comprise a Synchronisation Signal Block SSB or a channel status information reference signal (CSI-RS)).

In some examples, the mobility trigger may comprise an indication as to whether a field indicating a QCL source RS ID is present in the mobility trigger. The QCL source RS ID may comprise, for example, a Synchronisation Signal Block SSB; channel status information reference signal (CSI-R or channel status information reference signal CSI-RS with tracking reference signal (TRS) info identifier.

In some examples, the mobility trigger may include indication whether or not a field comprising a TCI state ID is present. The TCI state ID may indicate for example, a Synchronisation Signal Block SSB; channel status information reference signal (CSI-R or channel status information reference signal CSI-RS with tracking reference signal (TRS) info identifier.

In some examples, the mobility trigger may comprise an indication that a field comprising, for example, a QCL source RS ID is not present. In some examples, the mobility trigger may include indication that a field comprising, for example, a TCI state ID, is not present. In some examples, the mobility trigger may include indication that a field comprising QCL source RS ID or TCI state ID is present (or that neither are present).

Implementations and arrangements described leverage information provided to a UE, for example, by TCI state indicators, and/or by mobility trigger signalling. Such information may provide assistance which can facilitate a UE being able to communicate with a target cell without requiring UE have a complete set of configuration information from a target network node. For example, user equipment may be able to implement an active TCI State for a target cell, before the target cell activates a TCI state. The UE does not need to be pre-activated with TCI States that it applies upon handover i.e. the beam indication does not have to refer to a candidate RRC configuration that is not yet active (before the handover). Such implementations and arrangements relax UE implementation requirements and simplify network signalling required in support of a mobility event.

According to various arrangements, L1/L2 mobility mechanisms may be implemented as described in more detail below.

According to one arrangement, a UE may be configured to receive an information, for example, a configuration, about reference signal(s) received by the UE from one or more network access node. The configuration of information may comprise at least one TCI state configuration. The TCI state configuration may comprise at least one TCI state associated with a cell other than a serving cell of the UE. The cell may be supported by a target network node. According to one arrangement, a UE may be configured to receive an indication of information about reference signal(s) received by the UE from one or more network access node. The indication of information may comprise indication at least one TCI state configuration applied for communication (for example, for transmission and/or reception).

The UE may be configured to receive a trigger (which may, for example, comprise a command or indication) to switch to a new target cell. The trigger may be associated with a TCI state associated with the new target cell. The UE may be configured to determine, based on the TCI state configuration provided, a Downlink (DL) Reference Signal (RS) indicated by the TCI state, or the QCL source RS (for example, Synchronisation Signal Block (SSB)) of the RS indicated by the TCI state.

The UE may perform that determination without a need to interpret or mapping the TCI state ID to the new target cell configuration, since it was provided in the format of the source cell TCI state indicators. The UE may be configured to apply the determined DL RS for monitoring at least one downlink channel and/or transmission of at least one uplink channel. The UE may be configured to then consider that it has not been provided with an indication of a TCI state or has not received activation for any TCI state in relation to the target cell. The UE may be configured to apply at least one rule for QCL assumption based on such a consideration.

According to some implementations, a UE may be configured to receive at least one indication of information about reference signal(s) receivable by the UE from one or more network access node. The indication may comprise an indication of a TCI state configuration. The TCI state configuration may comprise at least one TCI state associated with a Physical Cell Identity (PCI) other than the serving cell of the UE. In one example, the UE may be configured with TCI state that comprises SSB index associated with a cell having a different PCI than the serving cell. In one example, the UE may be configured with TCI state that comprises CSI-RS index (with or without TRS information) associated with a cell having a different PCI than the serving cell.

In support of provision of such information to a UE, a network may be operable to (re)configure and provide new TCI configurations with tci-States ToAddModList and/or dl-OrJoint-TCIState (for Rel-17) defined in PDSCH-Config. This may be sometimes be referred to as a unified TCI State configuration.

According to some implementations, a UE may be configured to receive a mobility trigger (for example, a command, indication or measurement) which indicates that the UE is to switch from a serving cell to a target cell. According to some embodiments, the trigger command may be associated with the TCI state associated with the target cell. According to some arrangements, the UE may be provided with a TCI state relating to a cell having a different PCI to that of the serving cell, but provision of the TCI state indication without a mobility trigger does not itself trigger a cell switch. In other words, the beam indication provided to the UE is “pending” receipt of a mobility trigger.

In one example, the UE may receive a configured TCI state ID within a message also containing an LTM trigger command (for example, a configuration index, and a TCI state ID). In one example, the UE may receive a beam indication, for example, via MAC CE or MAC CE and DCI. In some examples, the UE may be configured to consider the beam indication as a cell switch command. In other words, in MAC CE and DCI, or MAC-CE the signalling may contain at least a configuration index, and DCI may contain a TCI state ID. According to some arrangements, a TCI state ID received by a UE may include a reference to Rel-15, Rel-17, any other TCI state framework, or a framework that indicates target cell beam indication. In some arrangements, a UE may be configured to receive a configuration index (for example, a RRC config) and a QCL RS ID directly in a trigger command. According to some arrangements, a UE may be configured to use QCL RS to monitor DL or/and UL channel of the new target cell until it receives a new TCI activation/indication from the new target cell. In some examples, the UE may be configured to apply a beam indication (for example, indication of a TCI State) as a cell switch command. Beam indication may be provided by a DCI message or MAC CE. The MAC CE or DCI indicating a beam may comprise a field indicating whether the beam indication is to be considered a mobility trigger by the user equipment. In one example, a UE configured to receive a beam indication that is considered as mobility trigger may determine: a DL RS indicated by a TCI state, or a QCL source RS (for example, SSB) of a RS indicated by the TCI state. The UE may be configured to apply the determined DL RS for reception and/or transmission of at least one channel. The UE may be further configured to operate on the basis that it has not received an indication of a TCI state in relation to the target cell.

In some implementations, the UE may be configured to determine a DL RS indicated by a TCI state, or a QCL source RS (for example, SSB) of a RS indicated by the TCI state. That determination may be made by the UE without interpreting or mapping the provided TCI state ID to the target cell configuration. According to one example, a UE may be configured to determine a DL RS indicated by the TCI State or the QCL source RS (typically SSB) and utilize that as a QCL assumption for one or more channels. In addition, the UE may be configured to determine that it has not been indicated with a TCI State for the target cell (for the target cell bandwidth part BWP).

According to one arrangement, the reference signal (or signals) included in or associated with or indicated by the mobility tigger may be reference signals listed in a network configured list (of reference signals). In one example, a network may configure nodes with a specific list, index or mapping of reference signals that can be included in, or indicated by, the mobility trigger. As an example, a network may configure a mobility trigger-specific reference signal list that can be indicated by at least one field in the mobility trigger. As an example of a list, a network may configure SSB #1 . . . SSB #N (associated with target cell PCI e.g. PCI #1). The mobility trigger may include an indication of a reference signal (e.g. SSB #1 . . . SSB #N). The indication may indicate a reference signal ID, for example, SSB #1 explicitly using the SSB identifier. Alternatively, the mobility trigger may include indication of a reference signal (e.g. SSB #1 . . . SSB #N). The indication may indicate the reference signal ID explicitly using a logical index (e.g. index #1, index #2). As a further example, if indices SSB #1 and SSB #5 are configured, the logical index for those SSBs would be 0 and 1 (or 1 and 2 depending on the first index). A UE may be configured to operate such that the indicated reference signal in the mobility trigger determines monitoring and/or reception and or transmission of at least one channel based on the reference signal. Alternatively (or additionally) the list of reference signals (identifiers) that can included in the indication included in the mobility trigger may be the list of reference signals that are configured for Layer 1 L1 reporting (e.g. Layer 1 Reference Signal Received Power L1-RSRP; Layer 1 Signal Interference and Noise Ration L1-SINR, or any L1 reporting associated with or used in Layer 1/Layer 2 Mobility LTM). In one example, the configuration index value (that indicates the target cell configuration) can be used to determine the PCI of the target cell and the listed reference signals are associated with a PCI via the configuration index. Alternatively, the reference signal configuration may associate the reference signals that can be indicated by (included in) the mobility trigger with a specific PCI. The list of reference signals that can be indicated by the mobility trigger may comprise of list of reference signals of one or more PCIs (i.e. single list per candidate target cell, or single list for all the target cells).

In some implementations, the UE may be configured to apply a determined DL RS for monitoring at least one downlink channel and/or transmission of at least one uplink channel. In some arrangements, after receiving a mobility trigger, a UE may be configured to assume the information provided by the TCI State indicator (for example, the DL RS) as QCL information for at least one of: PDCCH, PDSCH, PUCCH, PUSCH. In one arrangement, if a codepoint indicates TCI States for both DL and UL, a UE may be configured to apply the QCL assumptions of an indicated RS by the TCI States for DL and UL. In one arrangement, if a codepoint indicates TCI States for DL, a UE may be configured to apply the QCL assumptions of an indicated RS by the TCI States for DL and UL (channels). In one arrangement, if a codepoint indicates TCI States for UL, a UE may be configured to apply the QCL assumptions of an indicated RS by the TCI States for DL and UL (channels). In one arrangement, the UE expects the mobility trigger to indicate a codepoint that indicates TCI States for at least downlink or both DL and UL (e.g. joint TCI state),

In some implementations, the UE may be configured to determine that it has not been directly provided with a TCI state nor received activation for any TCI state in relation to the target cell. In some arrangements, the UE may be configured, once it has completed the RRC reconfiguration (i.e. the handover is complete), to assume that it has not been activated with a TCI state, but may maintain a QCL assumption for monitoring or transmitting the DL and UL channels until it receives a new activation or beam indication (TCI state indication) from the new target cell. In some arrangements, the UE may be configured to apply at least one rule for determining QCL assumptions based on a determination that a TCI State has not been directly activated or indicated to the UE by the target cell.

In some arrangements, if a MAC CE provides information relating to a mobility trigger to a UE (for example, via a mobility trigger MAC CE) to trigger a cell switch, that information may comprise at least one field indicating whether the trigger command will include a TCI or a DL RS of the target cell. The field may, for example, be identified via the configuration index. In some arrangements, the configuration index may comprise a target cell RRC configuration. If a field in the MAC CE indicates that a TCI State is present in the mobility trigger, a UE may be configured to operate as set out herein. If a field in the MAC CE indicates that a DL RS is present in the mobility trigger, a UE may be configured to operate as described herein and selecting to use a DL RS as a QCL source for at least one downlink and/or uplink channel. If a field in the MAC CE indicates that no TCI State (or DL RS) is present in the mobility trigger, a UE may be configured to trigger a contention based random access procedure in relation to the target cell indicated by the configuration index. If a UE has received an indication of a TCI state for a target cell (for example, if operating in inter-cell beam management, but has not yet received mobility trigger) the UE may be configured to use the currently indicated TCI State relating to the target cell to be valid for the methods described herein

By way of one specific example implementation, consider a possible implementation in for PDCCH monitoring: For a CORESET other than a CORESET with index 0, if a UE has not been provided a configuration of TCI state(s) by tci-StatesPDCCH-ToAddList and tci-StatesPDCCH-ToReleaseList for the CORESET, or has been provided initial configuration of more than one TCI states for the CORESET by tci-StatesPDCCH-ToAddList and tci-StatesPDCCH-ToReleaseList but has not received a MAC CE activation command for one of the TCI states as described in [11, TS 38.321], the UE assumes that the DM-RS antenna port associated with PDCCH receptions is quasi co-located with the SS/PBCH block the UE identified during the initial access procedure, or for a most recent configured grant PUSCH transmission as described in clause 19 for a same HARQ process, (opt1) or the most recent CSI-RS configured with TRS-info or SSB associated with PCI other than serving cell provided to UE indicated by the TCI information; (opt2) or the most recent CSI-RS or SSB index provided to UE by the mobility trigger/LTM trigger command (or any message triggering cell switch to a new target cell); (opt3) or the most recent CSI-RS or SSB index provided to UE by the mobility trigger/LTM trigger command in serving cell (PCI) indicated by the configuration index (or in any message triggering cell switch to a new target cell).

User equipment according to claim 1, wherein for a CORESET other than a CORESET with index 0, if the user equipment has not been provided with a configuration of Transmission Configuration Indicator state(s) by: tci-StatesPDCCH-ToAddList and tci-StatesPDCCH-ToReleaseList for the CORESET; or has been provided initial configuration of more than one Transmission Configuration Indicator TCI states for the CORESET by tci-StatesPDCCH-ToAddList and tci-StatesPDCCH-ToReleaseList but has not received a MAC CE activation command for one of the TCI states; the user equipment is configured to:

assume that a demodulation reference signal DM-RS antenna port associated with Physical Downlink Control Channel PDCCH reception is quasi co-located with a Synchronisation Signal/Physical Broadcast Channel SS/PBCH block as identified by the user equipment for a most recently received Channel Status Information Reference Signal CSI-RS configured with Tracking Reference Signal TRS-info or a Synchronisation Signal Block SSB associated with a Physical Cell Identity PCI other than a serving cell provided to the user equipment indicated by determined Transmission Configuration Indicator TCI information; or optionally for the most recent Channel Status Information Reference Signal CSI-RS CSI-RS or Synchronisation Signal Block SSB index provided to the user equipment by a received configuration index provided by the mobility trigger or determination that the user equipment is configured to apply layer 1 or layer 2 triggered mobility as part of a Layer1/layer 2 triggered mobility LTM trigger command.

In any of the embodiments herein the mobility trigger (and any information that it provides) may be provided by a MAC CE or DCI.

Having described general implementations and options, four specific examples are now described in relation to the enclosed drawings.

To ease understanding, throughout the specific examples, the cells 20a and 20b may be related to a general 5G NR topology as described previously as follows: Cell 1 (20a) may be provided by, for example, DU1 and DU1 may be connected to, for example, CU1. Cell 20b may, for example, in a general case be such that it is provided by DU1 where DU1 is connected to CU1; or cell 20b may be provided by DU2 and DU2 may be connected to CU1; or cell 20b may be provided by DU2 and DU2 may be connected to CU2, and similar.

FIG. 3 is a signalling diagram illustrating signalling between a serving cell 20a and a UE 10, in support of one possible implementation. A mobility event, in which a cell change occurs to a cell 20b, is supported according to the following signalling steps. The steps illustrated in the FIG. 3 may be performed in different order, as an example step S5 may precede step S4. As an example, UE may apply the determined RS/source RS for performing the cell change related signalling (such as RRC messages/MAC CE). Additionally, UE may continue to perform actions set out in step S5 after step S4 has occurred (i.e. after the cell change)
S1: RRC signalling from the serving cell 20a is received at the UE. That signalling configures the UE with L1/L2 triggered mobility.
S2: the serving cell provides the UE 10 with a MAC CE triggering mobility of the UE to cell 2, 20b. The MAC CE includes either a TCI state or QCL source information to the UE in relation to the target cell, 20b.
S3: The UE is configured to determine a reference signal (RS) or source RS indicated by the TCI state provided in the MAC CE.
S4: The UE 10, serving cell 20a and target cell 20b perform a cell change.
S5: The UE applies the determined RS for monitoring at least one downlink channel from cell 2 (20b) and/or transmission of at least one uplink channel.
S6: the UE is configured to assume it has no TCI state information (e.g. it has not been indicated to apply a TCI state) in relation to cell 2 20b. As a further example, UE is configured to assume that it has not been indicated with a TCI state to be applied for communication (and it continues to apply the determined RS for communication).

FIG. 4 is a signalling diagram illustrating signalling between a serving cell 20a and a UE 10, in support of one possible implementation. A mobility event, in which a cell change occurs to a target cell 20b, is supported according to the following signalling steps:
T1: RRC signalling from the serving cell 20a is received at the UE. That signalling configures the UE with L1/L2 triggered mobility.
T2: the serving cell provides the UE 10 with a MAC CE mobility trigger instructing the UE to change to cell 2, 20b. The MAC CE does not include either a TCI state or QCL source indicator and so the UE has no information available in relation to the target cell, 20b.
T3: The UE determines that no TCI state or QCL source RS information has been included in the mobility trigger.
T4: The UE 10 is configured to recognise a random access procedure to activate a transfer to cell 2, 20b, is require to perform a cell change.
T5: The UE is configured to transmit a random access request to target serving cell 2.

FIG. 5 is a signalling diagram illustrating signalling between a serving cell 20a and a UE 10, in support of one possible implementation. A mobility event, in which a cell change occurs to a target cell 20b, is supported according to the following signalling steps. The steps illustrated in the FIG. 5 may be performed in different order, as an example step U6 may precede step U5. As an example, UE may apply the determined RS/source RS for performing the cell change related signalling (such as RRC messages/MAC CE). Additionally, UE may continue to perform actions of U6 after U5 (i.e. after the cell change)
U1: RRC signalling from the serving cell 20a is received at the UE. That signalling configures the UE with L1/L2 triggered mobility.
U2: the serving cell provides the UE 10 with a MAC CE including a beam indication relating to cell 2 20b. The beam indication may comprise a TCI state or ICBM of cell 2.
U3: the serving cell provides the UE 10 with a MAC CE mobility trigger instructing the UE to change to cell 2, 20b. The MAC CE does not include either a TCI state or QCL source indicator.
U4: The UE 10 is configured to determine the RS or source RS of cell 2 based upon the TCI state in ICBM.
U5: The UE 10, serving cell 20a and target cell 20b perform a cell change.
U6: The UE applies the determined RS for monitoring at least one downlink channel from cell 2 (20b) and/or transmission of at least one uplink channel.
U7: the UE is configured to assume it has no TCI state information (e.g. it has not been indicated to apply a TCI state) in relation to cell 2 20b. As a further example, UE is configured to assume that it has not been indicated with a TCI state to be applied for communication (and it continues to apply the determined RS for communication).

FIG. 6 is a signalling diagram illustrating signalling between a serving cell 20a and a UE 10, in support of one possible implementation. A mobility event, in which a cell change occurs to a target cell 20b, is supported according to the following signalling steps. The steps illustrated in the FIG. 6 may be performed in different order to that shown. By way of example, step V7 may precede step V6. As an example, UE may apply the determined RS/source RS for performing the cell change related signalling (such as RRC messages/MAC CE). Additionally, UE may continue to perform actions of step V7 after step V6 (i.e. after the cell change)
V1: RRC signalling from the serving cell 20a is received at the UE. That signalling configures the UE with L1/L2 triggered mobility.
V2: The serving cell provides the UE 10 with a MAC CE including a beam indication relating to cell 2 20b. The beam indication may comprise a TCI state or ICBM of cell 2.
V3: The UE 10 and cell 2 communicate using the TCU state provided in V2 as a QCL assumption for monitoring. Cell 1 remains the serving cell.
V4: The serving cell 20a provides the UE 10 with a MAC CE triggering mobility of the UE to cell 2, 20b. The MAC CE includes either a TCI state or QCL source information to the UE in relation to the target cell, 20b.
V5: The UE 10 is configured to determine the RS or source RS of cell 2 based upon the TCI state, overriding the TCI state QCL assumption based on step V2.
V6: The UE 10, serving cell 20a and target cell 20b perform a cell change.
V7: The UE applies the determined RS for monitoring at least one downlink channel from cell 2 (20b) and/or transmission of at least one uplink channel.
V8: the UE is configured to assume it has no TCI state information (e.g. it has not been indicated to apply a TCI state) in relation to cell 2 20b. As a further example, UE is configured to assume that it has not been indicated with a TCI state to be applied for communication (and it continues to apply the determined RS for communication).

FIG. 7 is a flowchart illustrating schematically steps according to one arrangement. A UE according to the methodology shown in FIG. 7 is configured to perform the following steps:
100: receive configuration for at least one TCI state, wherein the TCI state is associated with a Physical Cell ID other than the UE serving cell
200: receive at the US a trigger for a cell switch, wherein the cell switch indicates to the UE to switch to a new cell
300: determining whether a TCI State is associated with the cell switch trigger
400: Performing a cell switch according to the determined association with the TCI state and determining further at least one parameter of the associated TCI state and applying it for further communication with a target cell.

Implementations and arrangements described leverage information provided by the TCI state to a UE for communication with a target cell without requiring UE have active TCI State for the target cell, before the target cell activates a TCI state. The UE does not need to be pre-activated with TCI States that it applies upon handover i.e. the beam indication does not have to refer to a candidate RRC configuration that is not yet active (before the handover). Such implementations and arrangements relax UE implementation requirements and simplify network signalling required in support of a mobility event.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods. The tern non-transitory as used herein, is a limitation of the medium itself (i.e., tangible, not a signal) as opposed to a limitation on data storage persistency (e.g. RAM vs ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although example embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

When referring to one or more network nodes, one of the one or more network node may be a network node supporting the serving cell the user equipment is connected to.

When referring to a target network node, the target network node may be a network node supporting the target cell or target candidate cell to switch to from the serving cell.

The network node supporting the serving cell and the network node supporting the target cell or target candidate cell may be the same node or different nodes, both nodes being physically co-located or not.

When referring to a user equipment, the user equipment may be configured to, in response to detecting a mobility trigger or a received reference signal configuration including a configuration associated or associable with a reference signal receivable from the target network node,
monitor the reference signal receivable from the target network node in accordance with the detected associated configuration. The reference signal configuration can be part of a MAC CE beam indication ICBM, and the mobility trigger part of a MAC CE message.

The user equipment may further be configured to, in response to detecting both the mobility trigger and the received reference signal configuration including a configuration associated or associable with a reference signal receivable from the target network node, pick the most recent received configuration, and
monitor the reference signal receivable from the target network node in accordance with the detected associated configuration.

The user equipment may further be configured to, in response to detecting that neither the mobility trigger nor the received reference signal configuration including a configuration associated or associable with a reference signal receivable from the target network node, perform a random access procedure towards the target mode.

When referring to switching the user equipment connection, such switching may include a handover from the serving cell to the target cell, the UE may be performing e.g. a random access procedure to perform the handover/switch or without random access.

1-34. (canceled)

35. A user equipment configured to establish a connection towards a radio access network, the user equipment comprising:
at least one processor; and
at least one memory storing instructions that, when executed by the at least one processor, cause the user equipment at least to:
determine that the user equipment is configured to apply layer 1 or layer 2 triggered mobility;
receive a reference signal configuration associated with a reference signal receivable from one or more network node of the radio access network, wherein the configuration may comprise a configuration of a reference signal receivable from a target network node;
receive a mobility trigger indicating that the user equipment is to switch to the target network node, wherein the mobility trigger may include a configuration associated with a reference signal receivable from the target network node;
switch to the target network node;
assess whether the mobility trigger or received reference signal configuration includes a configuration associated with a reference signal receivable from the target network node, and if so,
monitor the reference signal receivable from the target network node in accordance with the assessed associated configuration.

36. User equipment according to claim 35, wherein the user equipment is further caused to:
assume that a reference signal configuration associated with a reference signal receivable from the target network node is unknown after the switch to the target network node.

37. User equipment according to claim 36, wherein the received reference signal configuration associated with a reference signal receivable from one or more network node of the radio access network comprises a Transmission Configuration Indicator state, and the configuration includes a Transmission Configuration Indicator state of a reference signal receivable from the target network node and wherein after the switch to the target network node, the user equipment is configured to not apply the Transmission Configuration Indicator state of the reference signal receivable from the target network node received prior to the switch to the target network node.

38. User equipment according to claim 35, wherein if the received reference signal configuration associated with a reference signal receivable from one or more network node of the radio access network includes a configuration of a reference signal receivable from a target network node, the user equipment is configured to:
monitor the reference signal receivable from the target network node in accordance with the assessed associated configuration at least until the mobility trigger is received.

39. User equipment according to claim 35, wherein assessing whether the reference signal configuration associated with a reference signal or mobility trigger includes a configuration of a reference signal receivable from the target network node comprises: selecting the reference signal configuration associated with a reference signal receivable from the target network node received in the mobility trigger in preference to any reference signal configuration associated with a reference signal receivable from the target network node included in the reference signal configuration associated with a reference signal receivable from one or more network node of the radio access network.

40. User equipment according to claim 35, wherein if the user equipment assesses that neither the reference signal configuration associated with a reference signal receivable from one or more network node of the radio access network nor mobility trigger includes a reference signal configuration associated with a reference signal receivable from the target network node; the user equipment is configured to:
initiate a random access request to the target network node indicated by the mobility trigger.

41. User equipment according to claim 35, wherein the user equipment is configured to monitor the reference signal receivable from the target network node in accordance with the assessed associated configuration at least until an updated reference signal configuration associated with a reference signal receivable from one or more network node of the radio access network is received from the target network node.

42. User equipment according to claim 35, wherein monitoring the the reference signal receivable from the target network node in accordance with the assessed associated configuration comprises: monitoring at least one downlink channel received from the target network node based on the reference signal receivable from the target.

43. User equipment according to claim 35, wherein the user equipment is configured to perform a transmission based upon the assessed associated target cell configuration at least until an updated reference signal configuration associated with a reference signal receivable from one or more network node of the radio access network is received from the target network node.

44. User equipment according to claim 43, wherein the transmission comprises: transmitting at least one uplink channel based on the reference signal receivable from the target.

45. User equipment according to claim 35, wherein the reference signal configuration associated with a reference signal receivable from the target cell of the radio access network comprises at least one inter-cell beam management ICBM indicator.

46. User equipment according to claim 35, wherein the reference signal configuration associated with a reference signal receivable from one or more network node of the radio access network comprises at least one Transmission Configuration Indicator TCI state indicator.

47. User equipment according to claim 46, wherein the user equipment is configured to determine a downlink reference signal or quasi-co-located source reference signal in dependence upon a received Transmission Configuration Indicator state.

48. User equipment according to claim 46, wherein the user equipment is configured with at least one Transmission Configuration Indicator state which maps to a downlink reference signal index associated with the target network node.

49. User equipment according to claim 46, wherein the user equipment is configured to
receive a Transmission Configuration Indicator state index which maps reference signals to Transmission Configuration Indicator states, the index being determined by the network.

50. User equipment according to claim 35, wherein the mobility trigger comprises a switch command or switch parameter to be met in relation to the target network node.

51. User equipment according to claim 35, wherein the mobility trigger comprises a medium access control layer control element MAC-CE or downlink control information DCI receivable by the user equipment.

52. User equipment according to claim 35, wherein the mobility trigger comprises: a Transmission Configuration Indicator TCI state which maps to a reference signal index associated with the target network node.

53. User equipment according to claim 35, wherein the mobility trigger comprises: a downlink reference signal configuration associated with the target network node.

54. User equipment according to claim 35, wherein
receiving a reference signal configuration associated with a reference signal receivable from one or more network node of the radio access network comprise: receiving at least one Transmission Configuration Indicator TCI state, and wherein the at least one configuration of a reference signal receivable from a target network node comprises a Transmission Configuration Indicator TCI state associated with a physical cell identity which differs from that of a serving cell of the user equipment; and wherein
receiving a mobility trigger indicating that the user equipment is to switch to the target network node, wherein the mobility trigger is associated with a Transmission Configuration Indicator TCI state associated with the target network node;
and wherein the user equipment is configured to:
determine a downlink reference signal indicated by the Transmission Configuration Indicator TCI state or a quasi co-located source reference signal of the reference signal indicated by the Transmission Configuration Indicator TCI state without mapping the Transmission Configuration Indicator TCI state to the target cell configuration;
switch to the target network node;
apply the determined downlink reference signal for monitoring at least one downlink channel and optionally transmission of at least one uplink channel; and
assess that the user equipment does not have a Transmission Configuration Indicator TCI state in relation to the target cell, and applied at least one rule for a quasi collocated assumption based on the applied reference signal.

55. User equipment according to claim 35, wherein for a CORESET other than a CORESET with index 0, if the user equipment has not been provided with a configuration of Transmission Configuration Indicator state(s) by: tci-StatesPDCCH-ToAddList and tci-StatesPDCCH-ToReleaseList for the CORESET; or has been provided initial configuration of more than one Transmission Configuration Indicator TCI states for the CORESET by tci-StatesPDCCH-ToAddList and tci-StatesPDCCH-ToReleaseList but has not received a MAC CE activation command for one of the TCI states;
the user equipment is configured to:
assume that a demodulation reference signal DM-RS antenna port associated with Physical Downlink Control Channel PDCCH reception is quasi co-located with a Synchronisation Signal/Physical Broadcast Channel SS/PBCH block as identified by the user equipment for a most recently received Channel Status Information Reference Signal CSI-RS configured with Tracking Reference Signal TRS-info or a Synchronisation Signal Block SSB associated with a Physical Cell Identity PCI other than a serving cell provided to the user equipment indicated by determined Transmission Configuration Indicator TCI information; or optionally
for the most recent Channel Status Information Reference Signal CSI-RS or Synchronisation Signal Block SSB index provided to the user equipment by a received configuration index provided by the mobility trigger or determination that the user equipment is configured to apply layer 1 or layer 2 triggered mobility as part of a Layer1/layer 2 triggered mobility LTM trigger command or an equivalent message triggering cell switch to a new target cell; or optionally
for the most recent Channel Status Information Reference Signal CSI-RS or Synchronisation Signal Block SSB index provided to user equipment by the mobility trigger or determination that the user equipment is configured to apply layer 1 or layer 2 triggered mobility as part of a Layer1/layer 2 triggered mobility LTM trigger command from the user equipment serving cell indicated by a configuration index or in any message triggering cell switch to the target cell.

56. User equipment according to claim 35, wherein:
the received reference signal configuration associated with a reference signal receivable from one or more network node of the radio access network does not comprise a configuration of a reference signal receivable from a target network node;
and the received mobility trigger indicating that the user equipment is to switch to the target network node does include a configuration of a reference signal receivable from the target network node; and wherein the user equipment is caused to:
switch to the target network node;
and monitor the reference signal receivable from the target network node in accordance with the configuration of the reference signal receivable from the target network node included in the received mobility trigger.

57. User equipment according to claim 35, wherein:
the user equipment is connected to a serving cell;
wherein the received reference signal configuration associated with a reference signal receivable from one or more network node of the radio access network is received from the serving cell and does not comprise a configuration of a reference signal receivable from a target network node;
wherein the received mobility trigger comprises a medium access control layer control element MAC CE message from the serving cell indicating that the user equipment is to switch to the target network node and includes a configuration of a reference signal receivable from the target network node in the form of a transmission configuration indicator TCI state or Quasi Co-located QCL source information relating to the target cell;
and wherein the user equipment is caused to:
determine a reference signal or source reference signal indicated by the TCI state or Quasi Co-located QCL source information;
switch to the target network node;
and monitor the reference signal receivable from the target network node by applying the determined reference signal for monitoring at least one downlink channel and optionally transmission of at least one uplink channel and wherein the user equipment is caused to
consider it does not have an indicated transmission configuration indicator TCI state in relation to the target cell.

58. User equipment according to claim 35, wherein:
the received reference signal configuration associated with a reference signal receivable from one or more network node of the radio access network does not comprise a configuration of a reference signal receivable from a target network node;
and the received mobility trigger indicating that the user equipment is to switch to the target network node does not include a configuration of a reference signal receivable from the target network node; and wherein the user equipment is caused to:
determine that it is to switch to the target network node;
and initiate a random access request to the target cell.

59. User equipment according to claim 35, wherein:
the user equipment is connected to a serving cell;
the received reference signal configuration associated with a reference signal receivable from one or more network node of the radio access network is received from the serving cell and does not comprise a configuration of a reference signal receivable from a target network node;
and the received mobility trigger comprises a medium access control layer control element MAC CE message from the serving cell indicating that the user equipment is to switch to the target network node and does not include a configuration of a reference signal receivable from the target network node; and wherein the user equipment is caused to:
determine that it is to switch to the target network node;
and initiate a contention based random random access request to the target cell.

60. User equipment according to claim 35, wherein:
the received reference signal configuration associated with a reference signal receivable from one or more network node of the radio access network comprises a configuration of a reference signal receivable from a target network node;
and the received mobility trigger indicating that the user equipment is to switch to the target network node does not include a configuration of a reference signal receivable from the target network node; and wherein the user equipment is caused to:
switch to the target network node;
and monitor the reference signal receivable from the target network node in accordance with the configuration of the reference signal receivable from the target network node included in the received reference signal configuration associated with a reference signal receivable from one or more network node of the radio access network.

61. User equipment according to claim 35, wherein:
the user equipment is connected to a serving cell;
the received reference signal configuration associated with a reference signal receivable from one or more network node of the radio access network comprises medium access control layer control element MAC CE message from the serving cell and comprises a transmission configuration indicator TCI state or Inter cell Beam Management ICBM indication relating to the target cell;
and the received mobility trigger comprises a medium access control layer control element MAC CE message from the serving cell indicating that the user equipment is to switch to the target network node, wherein the received mobility trigger does not include a configuration of a reference signal receivable from the target network node; and wherein the user equipment is caused to:
determine the reference signal or source reference signal indicated by the received transmission configuration indicator TCI state or Inter cell Beam Management ICBM indication;
switch to the target network node;
and monitor the determined reference signal receivable from the target network node by applying the determined reference signal for monitoring at least one downlink channel and optionally transmission of at least one uplink channel and wherein the user equipment is caused to
consider it does not have an indicated transmission configuration indicator TCI state in relation to the target cell.

62. User equipment according to claim 35, wherein:
the received reference signal configuration associated with a reference signal receivable from one or more network node of the radio access network comprises a configuration of a reference signal receivable from a target network node;
the user equipment is caused to communicate with the target cell using the received configuration of a reference signal receivable from a target network node, whilst leaving a serving cell unchanged;
wherein the received mobility trigger indicating that the user equipment is to switch to the target network node includes a configuration of a reference signal receivable from the target network node; and wherein the user equipment is caused to:
switch to the target network node;
and monitor the reference signal receivable from the target network node in accordance with the configuration of the reference signal receivable from the target network node receivable from the target network node included in the received mobility trigger.

63. User equipment according to claim 35, wherein:
the user equipment is connected to a serving cell;
the received reference signal configuration associated with a reference signal receivable from one or more network node of the radio access network comprises medium access control layer control element MAC CE message from the serving cell and comprises a transmission configuration indicator TCI state or Inter cell Beam Management ICBM indication relating to the target cell;
the user equipment is caused to
communicate with the target cell using the received transmission configuration indicator TCI state as a quasi colocated assumption for target cell monitoring whilst retaining the serving cell;
wherein the received mobility trigger comprises a medium access control layer control element MAC CE message from the serving cell indicating that the user equipment is to switch to the target network node and includes a configuration of a reference signal receivable from the target network node in the form of a transmission configuration indicator TCI state or Quasi Co-located QCL source information relating to the target cell;
and wherein the user equipment is caused to:
determine a reference signal or source reference signal indicated by the transmission configuration indicator TCI state or Quasi Co-located QCL source information included in the received mobility trigger, overriding the previous transmission configuration indicator TCI state or Quasi Co-located QCL assumption;
switch to the target network node;
and monitor the reference signal receivable from the target network node by applying the determined reference signal for monitoring at least one downlink channel and optionally transmission of at least one uplink channel and wherein the user equipment is caused to
consider it does not have an indicated transmission configuration indicator TCI state in relation to the target cell.

64. User equipment according to claim 35,
wherein the received mobility trigger comprises a medium access control layer control element MAC CE message indicating that the user equipment is to switch to the target network node and includes a configuration of a reference signal receivable from the target network node in the form of a transmission configuration indicator TCI state or Quasi Co-located QCL source information relating to the target cell.

65. User equipment according to claim 35, wherein
the user equipment is connected to a serving cell;
wherein the received reference signal configuration associated with a reference signal receivable from one or more network node of the radio access network is received from the serving cell; and
wherein the received mobility trigger comprises a medium access control layer control element MAC CE message from the serving cell indicating that the user equipment is to switch to the target network node and includes a configuration of a reference signal receivable from the target network node in the form of a transmission configuration indicator TCI state or Quasi Co-located QCL source information relating to the target cell.

66. A network node for a radio access network comprising:
at least one processor; and
at least one memory storing instructions that, when executed by the at least one processor, cause the user equipment at least to:
determine that a user equipment is configured to apply layer 1 or layer 2 triggered mobility;
provide to the user equipment a reference signal configuration associated with a reference signal receivable from one or more network node of the radio access network, wherein the configuration may comprise an configuration of a reference signal receivable from a target network node;
provide a mobility trigger to the user equipment indicating that the user equipment is to switch to the target network node, wherein the mobility trigger may include a configuration associated with a reference signal receivable from the target network node.

67. A method performed by a network node of a radio access network; the method comprising:
determining that a user equipment is configured to apply layer 1 or layer 2 triggered mobility;
providing to the user equipment a reference signal configuration associated with a reference signal receivable from one or more network node of the radio access network, wherein the configuration may include an configuration of a reference signal receivable from a target network node;
providing a mobility trigger to the user equipment indicating that the user equipment is to switch to the target network node, wherein the mobility trigger may include a configuration associated with a reference signal receivable from the target network node.

68. A computer program product operable, when executed on a computer, to perform the method of claim 67.
